(19) United States
(12) Patent Application Publication
(10) Pub. No.: US 2009/0200965 A1
(43) Pub. Date: Aug. 13, 2009

(54) ENERGY SAVINGS CIRCUITRY FOR A LIGHTING BALLAST

(75) Inventor: Ray James King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PureSpectrum, Inc.

(21) Appl. No.: 12/366,886

(22) Filed: Feb. 6, 2009

Related U.S. Application Data
(60) Provisional application No. 61/006,966, filed on Feb. 8, 2008.

(51) Int. Cl. H05B 41/36

(52) U.S. Cl. 315/307

(57) ABSTRACT

Methods and apparatus for saving energy in a ballast comprising a tank circuit for a gas-discharge lamp are disclosed. A feedback circuit and a filament shutoff circuit cooperate to detect energy in the tank ballast and save energy during operation. The feedback circuit detects current flowing in the tank circuit of a ballast and can signal to shut off a voltage regulator in the ballast, and/or signal to a filament shut off circuit to reduce energy consumed by the filaments in the bulb after ionization has occurred. A time delay ensures that the signal voltage generated does not immediately deactivate the voltage regulator and/or the filament shutoff circuit when powering the ballast, but only does so after ionization has occurred. In this manner, energy consumption is reduced after ionization of the bulbs has occurred.

### RELATED APPLICATIONS

This application claims the benefit of U.S. Provisional Patent Application 61/006,966 entitled “Low Loss Lighting Ballast With Filament Shut-Off,” filed on Feb. 8, 2008, the contents of which are herein incorporated by reference.

### FIELD OF THE DISCLOSURE

The present disclosure relates generally to electronic lighting ballasts and, more particularly, to methods and apparatus for lighting ballasts having further energy detection and savings circuitry.

### BACKGROUND

In the field of light sources (e.g., gas discharge lamps, fluorescent lamps, light emitting diodes, etc.), many light sources can present a negative resistance that causes the power source to increase the amount of current provided. If the current were not limited in some manner during operation, the current would rapidly increase until there was a catastrophic failure of the light source. To limit the current, a ballast circuit is typically provided that controls the amount of current provided to the light source to maintain a steady state, flicker-free generation of light. Initial ballasts were of the magnetic type, which presented a large inductance to the power source. Such ballasts resulted in the current being largely in phase at the load with respect to the voltage provided by the power source, which resulted in a high power factor. However, magnetic ballasts had very poor efficiencies. Magnetic ballasts have other disadvantages including being relatively large and heavy, and are prone to producing an audible humming sound. Further, they are temperature dependent and when cold they may present difficulties in causing ionization in the lamp and therefore generating light. Magnetic ballasts have largely been replaced by quieter, smaller electronic ballasts to provide the proper starting and operating power to fluorescent lamps. Further, electronic ballasts are generally smaller and more compact and can be integrated with a fluorescent bulb (tube) to produce compact fluorescent lamps (“CFLs”). Electronic ballasts rely on electronic switching circuitry to switch the input voltage to produce a high frequency (typically 20 kHz or higher) voltage to the nodes of the fluorescent lamp. Typically, the ballast includes a “tank circuit” (a.k.a. resonant circuit) which increases the line voltage to a higher voltage, typically anywhere from 200 to 600 volts, so as to initiate ionization and maintain the light output of the fluorescent lamp during operation.

The power factor is generally defined as the relationship of the real power to the apparent power. However, electronic ballasts often exhibit a lower power factor, which means the current is not in phase with the voltage. A lower power factor means the power company has less efficiency in energy transmission. Further, as the use of fluorescent lighting becomes widespread, a lower power factor in residential applications becomes more of a concern to the power company. Some ballasts have incorporated a power factor correction circuit, which may include an integrated circuit, capacitor, and other components, which monitor and adjust the current flow so as to be in phase with respect to the line voltage, however, such power factor correction circuits generally have poor efficiency caused by losses due to these components and increase the cost of the ballast. See also, U.S. Pat. No. 5,804,929 that discloses using a high frequency bypass capacitor across the output of the rectifier configured to present a relatively high impedance at 120 Hz, similar to capacitor 120 shown in FIG. 1. Further, such ballast circuits generally include a low temperature, high voltage electrolytic capacitor that substantially limits the life of the ballast.

Electronic ballasts are generally relied upon exclusively for compact fluorescent light (“CFL”) because of their smaller size and weight, relative to magnetic ballasts, which allows a CFL to incorporate both a lamp (light source) and a ballast. Hence, a CFL has an integrated ballast with the lamp. In other applications, such as when using “linear” or “tubular” fluorescent bulbs, the ballast is separate from the lamps, allowing the lamp to be replaced separately from the ballast.

In the past, using ballasts precluded the ability to dim the light source. It becomes difficult to sustain ionization in the fluorescent tube at low dimming levels with conventional ballasts, causing the lamp to flicker. Newer ballasts now allow the light source to be dimmed to a degree, but still present problems in that the dimming is over a narrow range of light output. Specifically, many ballasts may effectively limit dimming to a narrow range of the light output before the light source is extinguished, or the lamp begins to flicker in an annoying manner. Further, the energy savings is not commensurate with the amount of light that is dimmed. Thus, if the light is dimmed a certain level (e.g., 25% of its output), one would expect the energy savings to be the commensurate (e.g., only 25% energy is used). However, in many cases, only a small fraction of energy is saved given the reduction in light output. Thus, the benefit of saving energy is not fully realized. Consequently, there is a need for a highly efficient and dimmable ballast for lighting applications.

In addition, some ballasts may provide energy to the filaments of the bulb to facilitate ionization. The voltage level at which a bulb ionizes is dependent on various factors, including the temperature within the bulb. Providing energy to the bulb filaments facilitates ionization by reducing the voltage ionization level. The energy can be provided in various arrangements by the ballast, including what is termed a current fed arrangement and a voltage fed arrangement. These arrangements provide either a current through the filaments or a voltage across the filaments prior to ionization. However, this energy is provided after ionization, which is not necessary, and reducing or eliminating the energy provided after ionization saves energy. Consequently, there is a need to reduce the energy provided to the filaments after ionization occurs.

Further, some ballasts may incorporate a linear voltage regulator to provide power at startup to the ballast, which may include an integrated circuit. Once the ballast is in a steady state, the voltage regulator is not necessarily the most efficient source of power to maintain the housekeeping energy to the bulb. Consequently, there is a need for a more efficient power source that is capable of replacing the voltage regulator after bulb ionization has occurred.

### SUMMARY

Methods and apparatus are disclosed for providing further energy savings in a lighting ballast. In one embodiment, a feedback circuit detects current in a tank circuit of a ballast circuit during operation and generates a signal voltage. The feedback circuit provides the signal voltage to the ballast and/or a filament shutoff circuit. The ballast can use the signal voltage to 1) deactivate a voltage regulator and 2) as a more efficient power source to other circuitry in the ballast.

The filament shutoff circuitry can use the signal voltage to reduce the energy consumption of the ballast after the bulb has been ionized. Specifically, in a current fed ballast arrangement, the filament shutoff circuit can reduce the current flowing through the filaments after ionization, and in a voltage fed arrangement, the filament shutoff circuit can reduce the voltage provided across the filaments after ionization. A time delay capability ensures that the filament shutoff circuit reduces energy only after the bulb has been ionized.

In addition, when using the filament shutoff circuitry, the signal voltage can be provided to the ballast to indicate when a bulb is present in the tank circuit. This allows the ballast to alter the operating frequency of the tank circuit when the tube is removed, which reduces the voltage present in the tank circuit and creates a safer operating condition when the bulb is removed as well as reducing energy consumption when no tube is present.

Further, the aforementioned voltage regulator shutoff capability can be combined with the filament shutoff capability to achieve additional energy savings.

### BRIEF DESCRIPTION OF THE DRAWINGS

FIGS. 1a-g illustrate a conventional prior art ballast circuit having a power factor correction circuit and various voltage waveforms produced therein.

FIGS. 2a-c illustrate a block diagram of one embodiment of ballast circuit according to the principles of the present invention having a high power factor in accordance with the present invention, along with voltage waveforms produced therein.

FIG. 3 is a flow diagram of a process that the example ballast circuit of FIG. 2a may implement.

FIGS. 4a and 4b are schematic diagrams of example circuits that may implement the example process of FIG. 3.

FIG. 4c illustrates waveforms of the voltage in conjunction with use of a dimmer.

FIG. 4d illustrates a schematic diagram of another embodiment of the present invention.

FIG. 5 illustrates a voltage waveform diagram associated with the operation of an exemplary rectifier of the circuit of FIG. 4a.

FIG. 6 is a voltage waveform diagram that illustrates the operation of an exemplary regulator of the circuit of FIG. 4a.

FIGS. 7 and 8 are circuits that illustrate the operation of the example circuit of FIG. 4a.

FIG. 9 is a voltage waveform diagram that illustrates the voltage at the light source in the resonant circuit of FIG. 4a.

FIGS. 10a-c illustrates one embodiment of an inductor core used in the tank circuit of the ballast.

FIG. 11a illustrates one embodiment of a feedback circuit for deactivating a voltage regulator in the ballast.

FIG. 11b illustrates one embodiment comprising a filament shutoff circuit for achieving further energy savings.

FIG. 11c illustrates one embodiment comprising a feedback circuit and a filament shutoff circuit for achieving further energy savings.

FIG. 12 illustrates another embodiment of an energy savings circuit.

FIG. 13 illustrates an alternate embodiment of the feedback circuit.

FIG. 14 illustrates an embodiment of the circuit for varying the integrated circuit driver frequency based on the signal voltage.

FIG. 15 illustrates an alternative embodiment of an energy savings circuit.

### DETAILED DESCRIPTION

Methods and apparatus for dimmable ballasts with a high power factor are described herein. In the described examples, a dimmable ballast circuit having a high power factor is described that directly interfaces a power source with a light source via a single resonant circuit. In addition, the described dimmable ballast includes a high frequency filter capacitor to reduce high frequency energy from entering the power supply during its operation to increase efficiency.

When an element is said to be “connected” or “coupled” to another element, the elements can be connected or coupled to one another either directly (without intervening elements) or indirectly (with intervening elements). However, if an element is said to be “directly connected” or “directly coupled” to another element, no intervening elements are present.

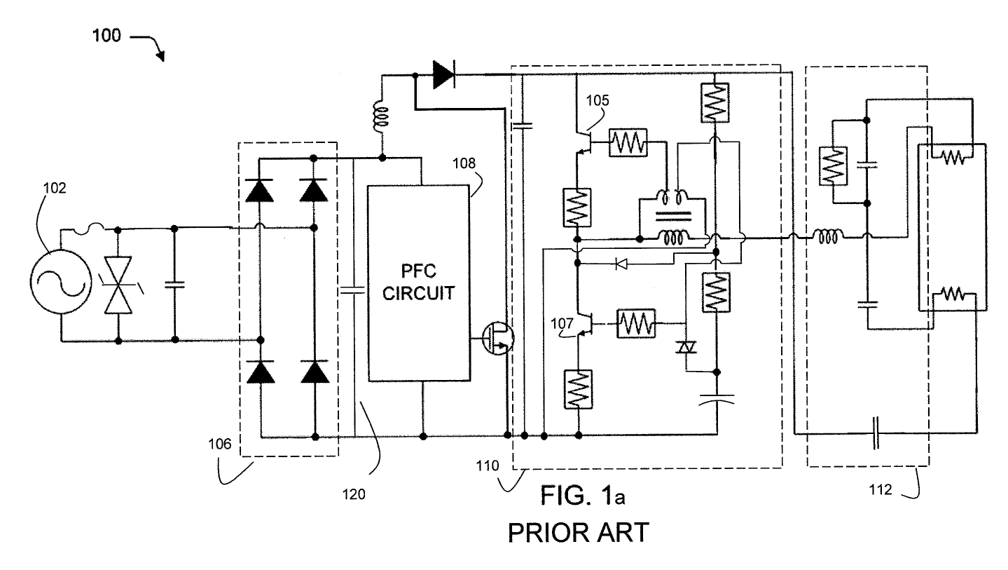

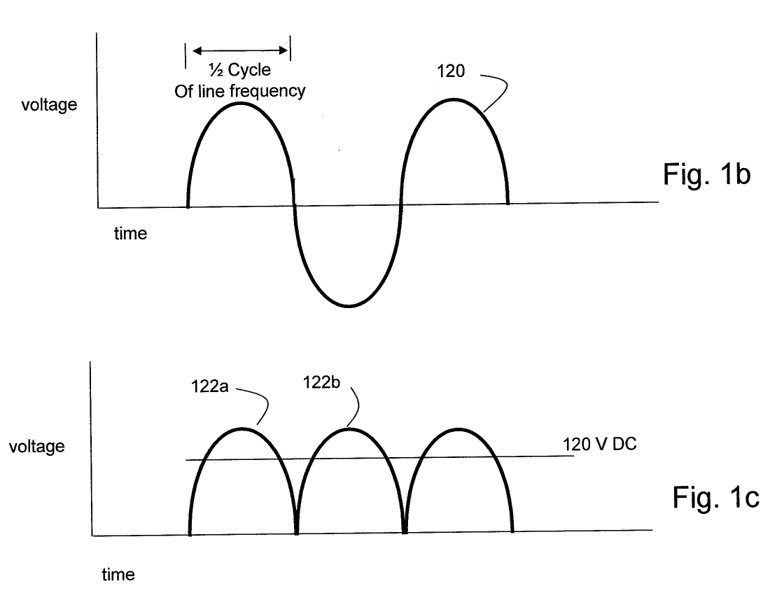

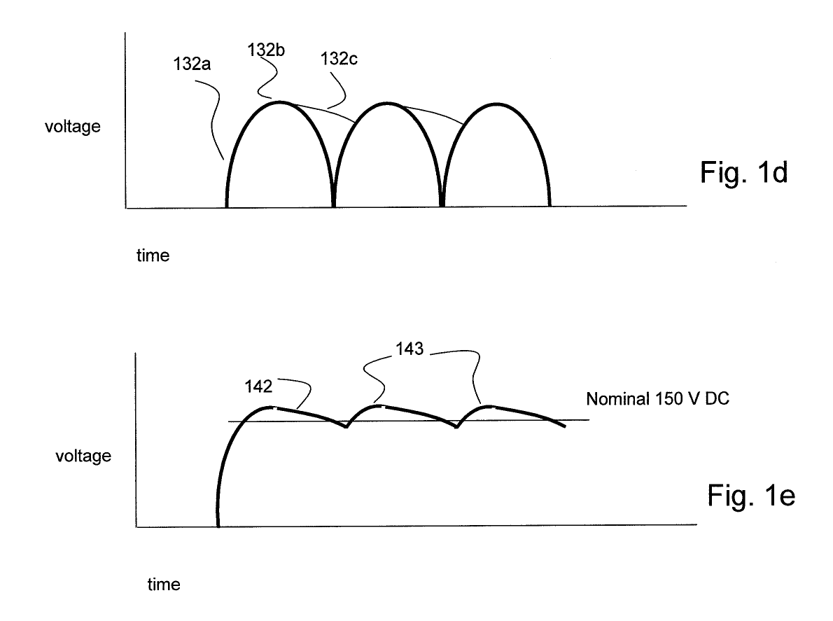

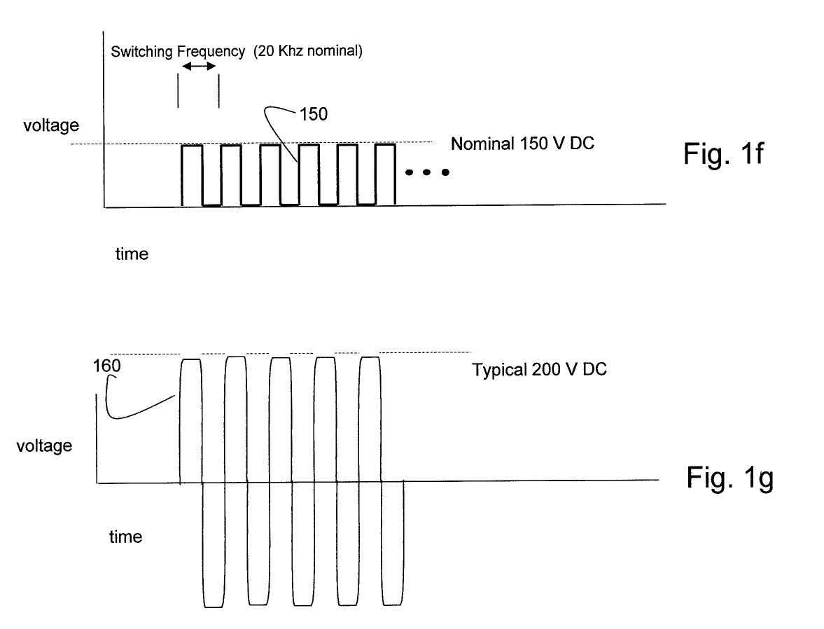

FIG. 1 illustrates one embodiment of a prior art electrical circuit ballast, comprising a power source 102, which provides household power, which typically is in the form of 120 VAC/60 Hz in the U.S., or 240 VAC/50 Hz in other countries. Although various embodiments herein may be disclosed in terms of “household voltage,” this means any readily available voltage, and does not preclude application to other commercial or industrial voltages. Thus, for example, the principles of the present invention could be adapted to other voltages and frequencies, such as the 400 Hz AC systems used in commercial aircraft. Hence, other variations are possible regarding the power source characteristics, which may impact the precise values of various components.

A rectifier 106 comprising a full wave bridge diode assembly rectifies the AC voltage to produce unfiltered, rectified DC voltage. The aforementioned power factor correction circuit 108 may be present, and typically may incorporate a high voltage electrolytic capacitor or other capacitor, integrated circuit, and other components. The switching circuit 110 typically comprises two transistors for switching at a high frequency, and incorporates a self resonant circuit for driving the transistors to switch at a high frequency, typically 20 kHz or higher. A so-called “tank” circuit 112 includes a combination of induction and capacitance values that functions to create a resonant frequency, and which increases the DC line voltage to a higher value, typically around 200 volts or more. In some contexts, the resistance values of the filaments in the bulbs can be considered as part of the tank circuit, since their resistance values impact the resonance frequency of the tank circuit. However, unless noted otherwise, the tank circuit as referenced herein does not include the bulb filaments. In various countries, such as in the U.S., Europe, or Asia, the resistance value of the filaments in the bulbs is respectively standardized to different values.

The voltage waveform produced by the power source 102 is shown in FIG. 1b. Typically, the voltage waveform 120 is a sine shaped waveform at a frequency of 60 Hz or 60 cycles per second, and thus a half cycle is 1/120 second. The voltage typically is rated at 120 volts (RMS) or about 160 volts peak in the U.S., although some minor variations may exist (e.g., some power companies may operate at 115 or 110 volts AC).

The voltage waveform 120 is provided to the input into the rectifier circuit of FIG. 1a, and the voltage waveform 122 in FIG. 1c is the output of the rectifier. In this instance, the negative portion of the waveform in FIG. 1b is inverted to form a positive portion 122b, thereby producing a rectified (AC) sine wave shape. Thus, each half cycle has the shape of a portion of a sine wave. The frequency of each waveform 122a, 122b is 120 Hz, or ½ the cycle time of the line frequency of 60 Hz (twice the rate). Consequently, the waveform shown is an unfiltered rectified sine wave.

In prior art ballasts, a large electrolytic capacitor is often incorporated either by itself, or as part of the power factor correction circuitry 108, to filter the 120 Hz ripple. The presence of this type of filter capacitor, which is designed to filter out the 120 Hz ripple in the rectified power wave, produces a waveform 132 shown in FIG. 1d. In FIG. 1d, the rise of the voltage 132a charges the electrolytic capacitor until a peak point of the waveform at 132b. At this point, the output voltage would normally be declining, but the capacitor discharges at 132c over time, preventing the rapid decrease in voltage of the rectified output. The result is the voltage waveform 142 shown in FIG. 1e, which after initial startup has a series of crests 143, which are followed by a slight decreasing voltage in between. The average voltage is typically slightly higher than the nominal AC line voltage rating, typically around 150 V, but in DC, but other embodiments with dedicated power factor correction circuits could be as high as 350v.

The switching circuit 110 of FIG. 1a alternatively switches transistor T1 105 and T2 107 on and off in a rapid sequence. Typically, while T1 is closed, T2 is open, and vice versa. However, there is typically some “dead time” between these events when both switches are open. The switching on and off typically occurs anywhere from 20 kHz to 100 kHz. Certain energy saving standards require a switching frequency of at least 40 kHz frequency. For illustrative purposes, the frequency can be assumed to be around 20 kHz. Generally, 18 kHz is a lower limit, and 80 kHz may be an upper limit.

In FIG. 1f, the switching voltage present across the transistor is shown as a square wave 150. Typically, the switching frequency is very high (e.g., 20 kHz) compared to the line frequency of 60 Hz (or 50 Hz), so that the time scale in FIG. 1f is different (i.e., expanded) relative to the time scale of the prior diagrams. The output of the transistors is essentially a square wave input to the tank circuit 112 of FIG. 1a.

The function of the tank circuit, which has a resonant frequency and which is tuned to be a slightly lower frequency than the switching frequency, is to re-circulate the energy introduced and “step up” the voltage introduced to around 200-600 volts. This voltage is high enough to initiate and maintain ionization on the fluorescent light bulb. The bulb itself, once ionized, serves to limit the voltage across its terminals. Thus, FIG. 1g illustrates a generally shaped sine wave 160 having a flattened top due to clamping caused by the ionization of the bulb, which for practical purposes can be considered a square wave. The wave of FIG. 1b has the same high switching frequency as FIG. 1a, but at a higher voltage, which would typically be present at the terminals of the lamp. A DC coupling capacitor filters out the DC component of the input into the tank circuit and causes the current flowing into the tube to be balanced, thus creating the negative portion of the sine wave in FIG. 1g (e.g., the symmetrical portion of the wave below zero volts). In the prior art, the bulb, once ionized, is continuously ionized during normal operation.

While this type of prior art circuit does provide suitable light generation in a lamp, it has difficulty in allowing dimming of the light source over a wide range of light output. Further, this type of prior art circuit is not energy efficient when dimmed. If it does not have the power factor correction circuit, then its power factor is low. If the power factor correction circuit is present, then the circuit contains additional components, increasing its cost.

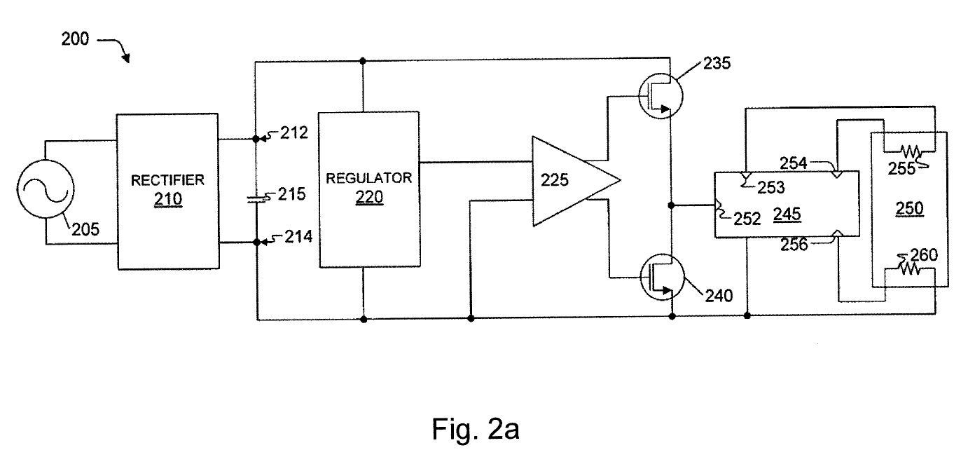

FIG. 2 illustrates a block diagram of one embodiment of the present invention wherein ballast circuit 200 is configured to have a high power factor, generally approaching a power factor of unity (e.g., 0.90-0.99, etc.). In particular, the example ballast circuit 200 includes a power factor correction capability that is performed in a single stage of impedance transformation, thereby eliminating the need for a separate high power factor correction circuit while retaining substantially the same functionality. Thus, fewer components are required relative to the prior art.

In the example of FIG. 2, the ballast 200 includes a power source 205 that is connected to a rectifier 210. The power source 205 is typically an alternating voltage source that provides commercially available voltage (e.g., 120 or 240 VAC) having a magnitude alternating at a line frequency (e.g., 60 Hertz (Hz)). A line filter (not shown) is also typically incorporated to prevent noise from being introduced back into the power network. Rectifier 210 is typically a full wave rectifier that inverts the negative magnitude of the voltage provided via the power source, thereby doubling the frequency of the line voltage (e.g., to 120 Hz). Rectifier 210 conveys the rectified voltage onto a first node 212 and a second node 214. The output of the rectifier 210 provided to nodes 212 and 214, is similar in waveform to that shown in FIG. 1c. The rectifier provides an unfiltered, rectified voltage. This voltage is DC, and has the shape of a rectified AC voltage waveform.

The first node 212 and the second node 214 are connected via a high frequency energy storage device, such as a polypropylene capacitor 215, also referred to as a bypass capacitor herein. In the example of FIG. 2, the capacitance value of the capacitor 215 is selected to have a value such that it presents a large impedance to the rectified voltage (i.e., at the line frequency), thereby not substantially affecting the rectified voltage provided via rectifier 210 during operation of the ballast. Typically, this would present an impedance of several thousand ohms at the line frequency. This would provide a low impedance at the switching frequency, typically in the range of less than 30 ohms. This is in distinction to the prior art that uses a high voltage, low frequency capacitor across the output of the rectifier, such as a large value electrolytic capacitor, to filter out the 120 Hz ripple due to the line frequency, which removes the “valleys” in the rectifier output. The capacitance value of capacitor 215 in the example of FIG. 2 is selected to store energy which is released at a high frequency, generally in the kilohertz (20-80 kHz) range. As such, capacitor 215 in the example of FIG. 2 has value of approximately 0.1 to 3 microfarads (μF) and is made of any suitable material (e.g., polypropylene, etc.) for a ballast having a power output as required, which in this embodiment is approximately 25 watts. In other embodiments, capacitor 215 may have a value of approximately 1 to 30 μF for a ballast having a power output of approximately 120 to 250 watts. Stated in more general terms, capacitor 215 generally has a capacitance value in the range of 4 to 120 nanofarads (nF) per watt of power of the output lamp, and typically around 50 nF/watt when 120 VAC is used. If 240 VAC is used, then capacitance value is half the above. The capacitor 215 is typically a polypropylene capacitor that has a lifespan much greater than larger electrolytic capacitors that typically are used in conventional ballasts.

Ballast circuit 200 also includes a regulator 220, (generically referred in the industry as a housekeeping supply circuit) connected to nodes 212 and 214. Regulator 220 generates a substantially constant voltage that exceeds a first threshold (e.g., 10 volts, etc.) to provide power to a driver 225. Because the voltage at nodes 212 and 214 is not filtered, a regulator is required to provide a steady input voltage to the driver 225. The voltage waveform from the rectifier has at each half cycle a “valley” wherein the voltage drops to zero or near-zero, albeit for a short time. In the illustrated example, the driver 225 is configured to alternately actuate one of a first transistor 235 and a second transistor 240 at a high frequency, referred to herein as the switching frequency, typically at a frequency of 20 kHz or more. The example transistors 235 and 240 are both implemented using vertical N-Channel metal oxide semiconductor (NMOS) field effect transistors, although one of ordinary skill in the art would know that the transistors 235 and 240 can be implemented by any other suitable solid state switching device (e.g., a P-channel metal oxide field effect transistor, an insulated gate bipolar transistor (IGBT), a lateral N-channel mode MOS transistor, a bipolar transistors, a thyristor, gate turn off (GTO) device, etc.).

Driver 225 and transistors 235 and 240 form a half-bridge topology that is implemented to cause a resonant circuit or “tank circuit” 245 to power a light source 250 in the illustrated example. To form the half-bridge topology, the drain of the first transistor 235 is connected to the first node 212 and the source of the second transistor 240 is connected to the second node 214. Thus, the voltage present on the node 212 and the drain of the first transistor 235 is the rectified voltage waveform 260 shown in FIG. 2b. The gates of the transistors 235 and 240 are both connected to first and second outputs of the driver 225, respectively, and the source of the transistor 235 is connected to the drain of the transistor 240, both of which are also connected to the resonant circuit 245. Because the transistor 235 switches the voltage from node 212 at a high frequency square wave 265 in FIG. 2b, the resulting voltage at input 252 is the high frequency square wave modulated by the line frequency as shown in FIG. 2c. Both FIGS. 2b and 2c illustrate the aforementioned “valleys” 260 having a period of twice the line frequency.

The resonant circuit 245 has a high resonant frequency that is slightly lower than the switching frequency of the transistors. Typically, the lowest frequency operable for practical purposes is 18 kHz, and the upper limit is limited by other practical considerations, but maybe as high as 80 kHz. The resonant circuit is also connected to the second node 214 and a light source 250 (e.g., a gas discharge lamp, a fluorescent lamp, a light emitting diode (LED), etc.).

In particular, a first input 252 is connected to the source and drain of NMOS transistors 235 and 240. A first output 253 of the resonant circuit 245 is connected to a second input 254 of the resonant circuit 245 via a first filament 255 of the light source 250. Further, in the example of FIG. 2, a second output 256 of the resonant circuit 245 is connected to the second node 214 via a second filament 260 of the light source (e.g., lamp or tube) 250. As will be described in detail below, the resonant circuit 245 can be viewed as a coupling device matching impedance of the tube with the power source. The resonant circuit functions to store energy and selectively charges and discharges energy into the light source 250 at the switching frequency, which greatly exceeds the line frequency of the rectified current which is at the line frequency, thereby exciting the light source 250 to visually emit light. Further, the resonant circuit 245 presents an impedance to the power source 205 to thereby limit the current flowing into the light source 250. The tank circuit increases the input line voltage by circulating energy in the tank circuit, and presents an alternating voltage across the ends of the bulb 250. In the present invention, the bulb is ionized or said to be ignited at the beginning of each half cycle (120 Hz) of the input power voltage.

The tank circuit presents a variable input impedance. When the input voltage at node 252 is just rising, such as shown with square wave 270 of FIG. 2c, the impedance is higher because of a high Q factor (which represents an unloaded circuit) of the tank circuit. When the input voltage is low, the bulb has not been ionized and the tank circuit has a high Q factor. As the input voltage increases, the bulb ionizes resulting in a lower Q factor of the tank circuit, allowing more current to flow. This means the current on the load is largely in phase with the voltage from the source, which results in a high power factor for the ballast.

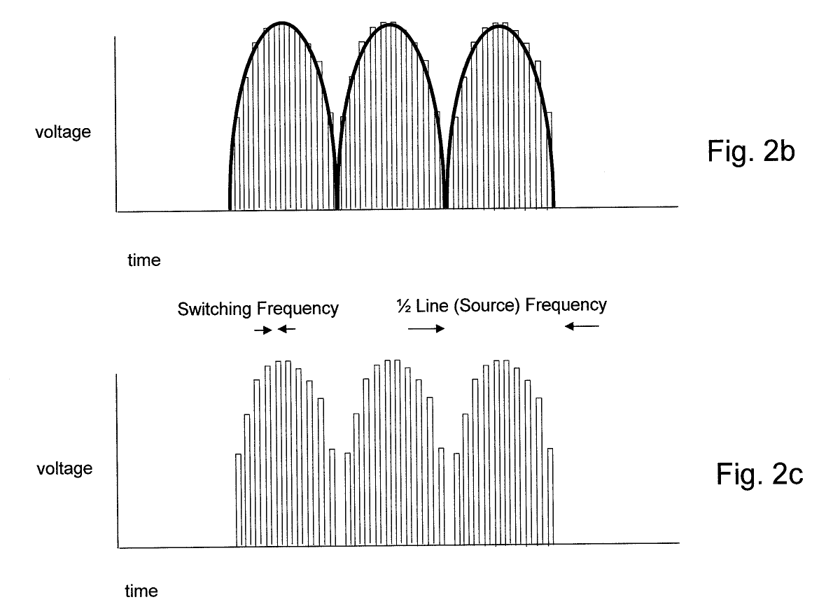

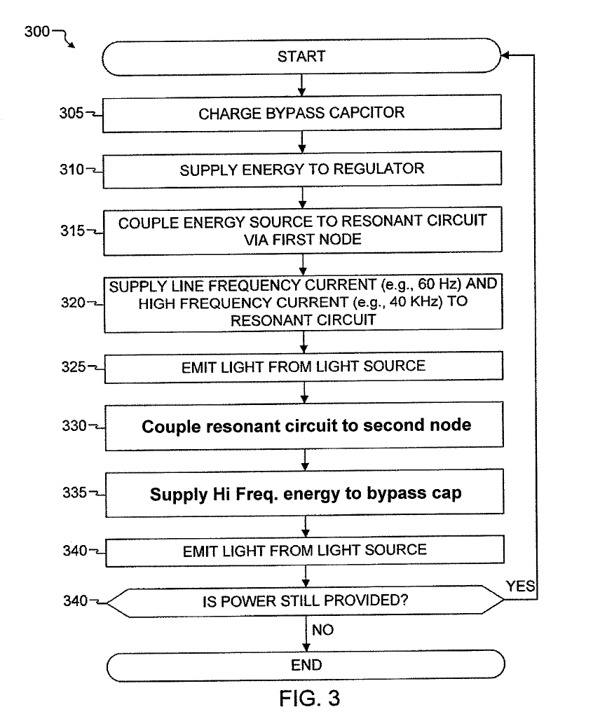

FIG. 3 illustrates an exemplary process 300 that ballast circuit 200 may implement when connected to a power source (e.g., an alternating current source, etc.). If power is provided to the ballast, exemplary process 300 begins by charging a high frequency bypass capacitor (corresponding to capacitor 215 of FIG. 2a). Specifically, the bypass capacitor presents a large impedance to a line frequency current of the power source (e.g., 60 Hz, 120 Hz, etc.) (block 310). In addition, exemplary process 300 supplies energy to power a regulator that provides power to actuate a driver circuit, for example (block 310). In the example of FIG. 3, exemplary process 300 couples the energy source (e.g., a power supply, etc.) to a resonant circuit via a first node (block 315). In response, the energy source supplies energy at the line frequency (60 Hz) which is combined with the energy from the capacitor at a high frequency (e.g., about 40 KHz, or whatever is the switching frequency) to the resonant circuit (block 320). In particular, the bypass capacitor provides the high frequency energy in the form of a current via the first node when the first transistor is closed. When the resonant circuit receives the line frequency energy and the high frequency energy (in the form of current), the resonant circuit has a voltage with a positive magnitude, thereby causing a light source connected to the resonant circuit to ionize the gas and emit light therefrom for the first half cycle (block 325).

After emitting light from the light source, exemplary process 300 then couples the resonant circuit to the second node (block 330). As a result, the resonant circuit has a voltage with a negative magnitude, and the energy is circulated within the tank circuit and within the bypass capacitor, thereby causing the light source connected to ionize the gas and emit light during the second half cycle (block 340). During this time, the bypass capacitor is also charged from the power source. Exemplary process 300 determines if power is still provided by the energy source (block 345). If power is provided, the exemplary process returns to block 305. On the other hand, if power is not provided to the ballast, the exemplary process ends. In the present invention, there is no ionization during a brief time period while the rectified unfiltered DC input voltage is in a “valley.” This point corresponds to the zero crossing point of the AC input line voltage. The time period during which the bulb is not ionized is typically at least 200 microseconds. However, this short time period is not perceivable to the human eye and the bulb may be generating light due to persistence of the phosphor in the bulb.

In the example of FIG. 3, the high frequency energy in exemplary process 300 is stored in the bypass capacitor, which continually recycles the high frequency energy during its operation. The high frequency current has a frequency generally in the range of approximately 20 to 80 KHz. Thus, according to exemplary process 300, the high frequency energy continually recycles via the bypass capacitor at the switching frequency, thereby preventing substantial energy loss. Further, the energy source is directly connected to the resonant circuit via a low impedance path to prevent substantial loss of energy. Accordingly, the resulting circuit implements a process generally having a high power factor, high efficiency, and a near ideal crest factor.

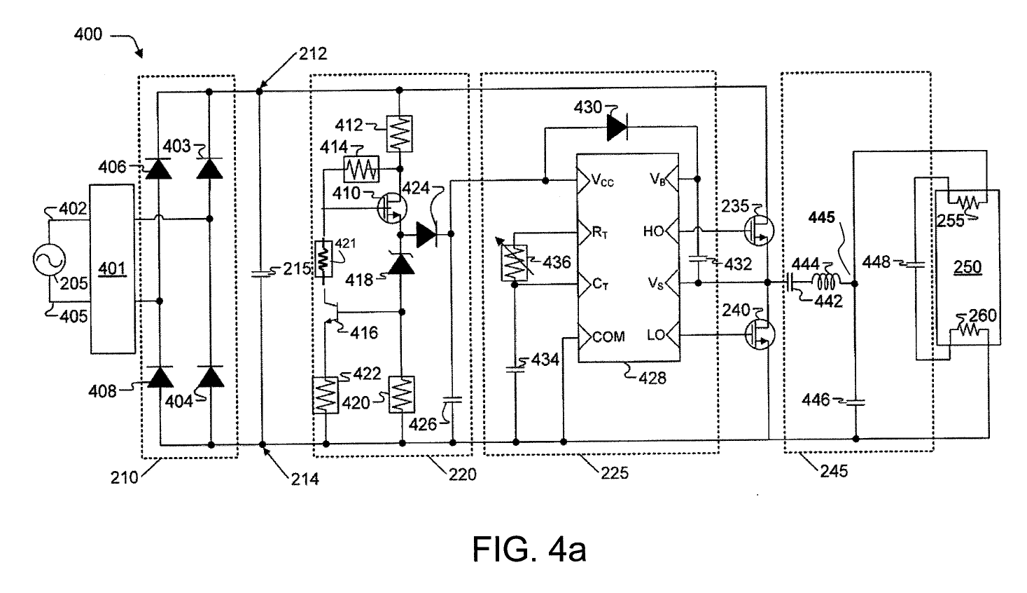

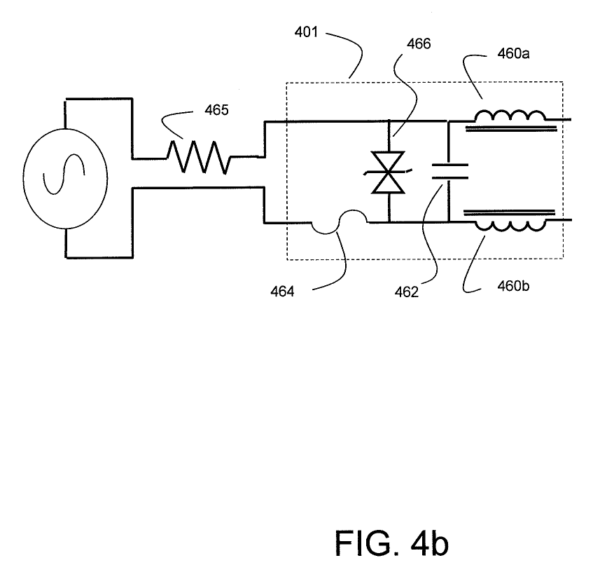

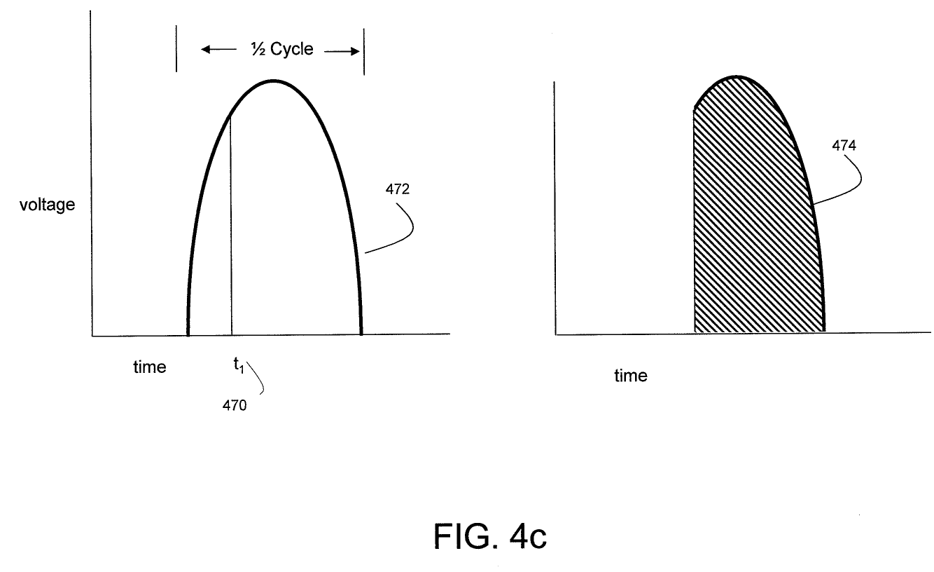

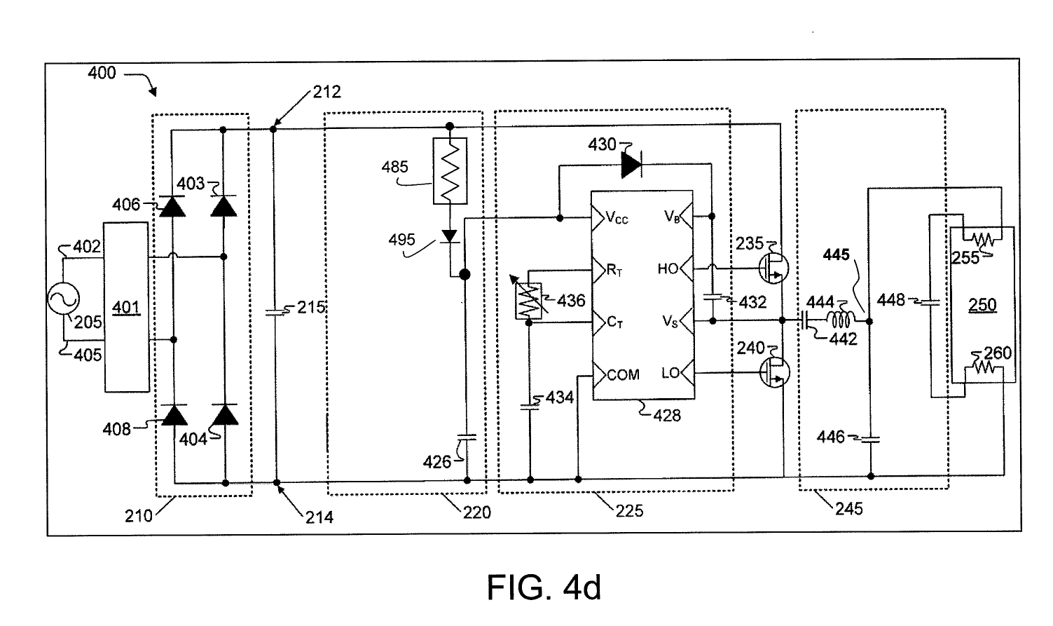

FIG. 4a is a schematic diagram of an exemplary circuit 400 that may implement exemplary process 300 (FIG. 3). In FIG. 4, power source 205 is connected to rectifier 210 via a line filter 401, which insulates power source 205 from noise due (e.g., electromagnetic interference, etc.) generated by the remainder of the ballast circuit. This is discussed in further detail below. More particularly, a first terminal 402 of the power source 205 providing household power is connected to the anode of a diode 403 and the cathode of a diode 404 via the line filter 405. The cathode of the diode 403 is connected to the first node 212 and the anode of the diode 404 is connected to the second node 214. Further, a second terminal 405 of the power source 205 is connected to the anode of a diode 406 and the cathode of a diode 408 via the line filter 405. The cathode of the diode 406 is connected to the first node 212 and the anode of the diode 408 is connected to the second node 214. The first node 212 and the second node 214 are connected via the capacitor 215, which presents a low impedance to high frequency energy.

The value of capacitor 215 is typically a 0.8-1.5 μF polypropylene capacitor for a 23 watt light source, and 0.22 μF for a 5 watt light source. The value can be adjusted as appropriate for the output load, but typically is 4 μF or less for a typical CFL. The value of capacitor 215 is small enough so as to not impact the output rectified voltage at node 212. Specifically, the value should not preclude the output voltage presented at node 212 from dropping down to 15% or less of its peak voltage of the rectifier output at the end of each half cycle. In other words, the voltage at the bottom of the “valley” should be no more than 10-18 volts.

Voltage regulator 220 is also connected to first and second nodes 212 and 214 and is configured to provide a substantially constant output voltage to the driver circuit. In the illustrated example, voltage regulator 220 is implemented using an NMOS transistor 410 that is connected to the first node 212 via a resistor 412. The drain of NMOS transistor 410 is connected to its respective gate via a resistor 414. The gate of NMOS transistor 410 is further connected to a collector of a transistor 416 via an optional resistor 421, which has its respective base connected to the anode of a zener diode 418. Resistor 421 reduces the gain of the transistor thereby reducing possibility of oscillations in transistor 410. The cathode of zener diode 418 is connected to the source of NMOS transistor 410.

In addition, the base of transistor 416 is connected to second node 214 via resistor 420 and its emitter is connected to the second node 214 via a resistor 422. In the example of FIG. 4, the source of the NMOS transistor 410 is connected to the cathode of a diode 424 and the anode of diode 424 is connected to the second node 214 via an energy storage device, such as a capacitor 426, (referred to herein as a housekeeping filter capacitor) which typically has a value of 10-30 μF. As will be described below, capacitor 426 stores energy therein to aid in providing a substantially constant voltage to the driver 225, even in conjunction with operation of a dimmer. The capacitor 426 also is used as a “bootstrap charging capacitor” for assisting diode 430 in charging capacitor 432 discussed below. Thus, capacitor 426 also functions in conjunction with the driver 225, but is shown as a component of regulator 220 for illustration sake.

In the illustrated example of FIG. 4a, driver 225 is implemented using any suitable circuit that selectively actuates transistors 235 and 240. Driver 225 in the exemplary circuit of FIG. 4a includes, for example, an International Rectifier™ 2153, which is a self-oscillating half-bridge driver circuit 428. However, one of ordinary skill in the art would understand that any suitable driver circuit could be implemented to perform the functions that the driver 225 provides (e.g., a 555 timer, processor, or other source of a suitable pulse, including PWM square wave generators, etc.). In other embodiments, transistors 235 and 240 may be integral with the driver circuit 428 (e.g., an integrated circuit such as the STMicroelectronics™ L6574, etc.).

Referring to the driver 225, regulator 220 provides the substantially constant (i.e., regulated) voltage via diode 424, which also isolates voltage regulator 220 from driver 225. Stated differently, diode 424 prevents current from flowing from capacitor 426 into regulator 220 when the voltage of the first node 212 falls below the voltage stored in capacitor 426. In the embodiment of FIG. 4, capacitor 426 and the cathode of diode 424 are also connected to the supply voltage (Vcc) of driver circuit 428 to provide a substantially constant voltage to driver circuit 428. The value of the capacitor may be sized so as to allow operation with a dimmer, such as a phase control dimmer, which may limit the voltage provided to the rectifier, and therefore to the ballast. Thus, even if a dimmer is dimming the input voltage by clamping of the input voltage wave form to the ballast for a certain time period, the capacitor must be sized to provide sufficient power to the driver to allow it to continue to operate through the greatest range of dimming. The capacitor 426 and the cathode of the diode 424 are also connected to the anode of a diode 430, which is connected to the high side floating supply voltage (VB) of the driver circuit 428 via its respective cathode. Further, the cathode of the diode 430 is connected the high side floating supply offset voltage (Vs) of the driver circuit 428 via a capacitor 432 this capacitor supplies the driver power for the switching FET 235.

In the illustrated embodiment of FIG. 4a, the frequency of driver circuit 428 is adjusted by selecting different resistance and capacitance values. More particularly, the oscillating timing capacitor input (C_{T}) on pin 3 of the driver circuit 428 is connected to the second node 214 via a capacitor 434. Further, the oscillator timing resistor input (R_{T}) of the driver circuit 428 is connected to the oscillating timing capacitor input (C_{T}) of the driver circuit 428 via an adjustable resistor 436 or impedance (e.g., a potentiometer, a transistor presenting a variable resistance or impedance, etc.). In such a configuration, the switching frequency of driver circuit 428 can be variably controlled by adjusting the resistance of resistor 436, which is typically set during manufacturing, for example. In other embodiments, a fixed resistance value for resistor 436 can be used.

In the illustrated example, the resistance value of the resistor 436 and the capacitance value of the capacitor 434 configure the driver circuit 428 to produce pulses at a frequency in the range of approximately 20 to 100 KHz. Specifically, the pulses are alternately produced by driver circuit 428 and are output via the high side gate driver output (HO) and the low side gate driver output (LO). Stated differently, during the first half cycle of a period of the switching frequency (i.e., the half of the time period for a single cycle), the high side gate driver output of the driver circuit 428 produces a pulse. During the second half cycle of the period (i.e., the low side of the cycle) of the switching frequency, the low side gate driver output of the driver circuit 428 produces a pulse. Typically, there is a dead time between pulses when neither transistor is turned on, e.g., the time after the first pulse ends and before the second pulse begins.

In the embodiment of FIG. 4a, the high side gate driver output (HO) is further connected to the gate of NMOS transistor 235 and the low side gate driver output (LO) on pin 5 is connected to the gate of NMOS transistor 240. In other examples, driver circuit 428 may be connected to the gates of transistors 235 and 240 via resistors to prevent parasitic oscillations, for example. If the resistors are present, these may be around 31 Ohms. NMOS transistors 235 and 240 are also connected to the high voltage floating supply return (Vs) of the driver circuit 428 via their source and drain, respectively. The drain of NMOS transistor 235 is connected to the first node 212 and the source of NMOS transistor 240 is connected to the second node 214.

As described above, the source of the NMOS transistor 235 and the drain of the NMOS transistor 240 are connected to the resonant or “tank” circuit 245, which selectively stores a charge therein. In the illustrated example, the resonant circuit 245 includes a capacitor 442 in series with an inductor 444. The capacitor 442 functions in part as a DC blocking capacitor. Its value is in some embodiments is 1/10 the value of capacitor 215 as a rough rule of thumb. However, other ratios can be used, but may not be optimized for the power factor. Typically, the capacitor 442 has a value from 1 μF to 0.01 μF.

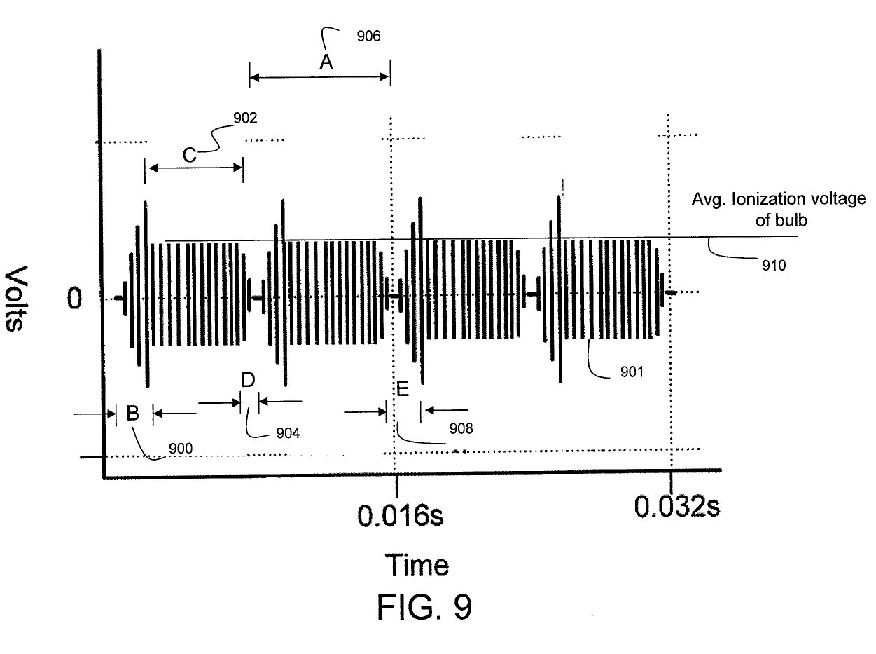

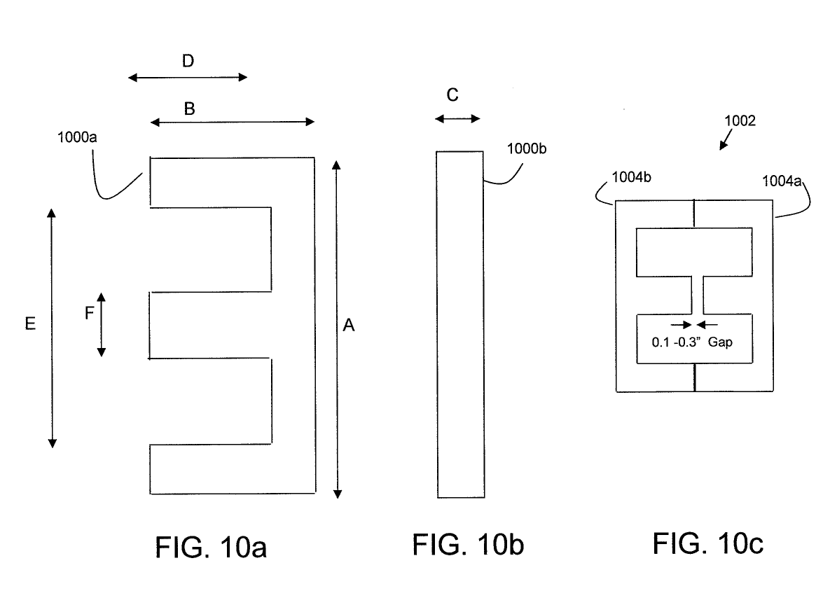

The inductor 444 is generally a gapped core inductor that is capable of handling a large peak current. The inductor is larger than what is used in a typical prior art ballast of the same power, because this inductor processes both the lower line frequency current (e.g., 120 Hz) as well as the higher, switching frequency current (e.g., 20-100 kHz) and must avoid saturation at the lower frequency. This is in contrast to prior art ballasts which process a filtered rectified DC output voltage, resulting in a largely constant DC voltage with little ripple. Hence, the prior art inductors in the tank circuit are not designed to conduct a line frequency current. In FIG. 4a, the inductor stores energy from both the low and high frequency currents. The inductor is gapped so as to reduce the heat caused during operation and to eliminate saturation at peak current of the low frequency current (which can be 3-4 amps, in some embodiments). The size of the gap depends on the permeability of the core material and is typically in a range of 0.1″ to 0.3″, which is much larger than found in a typical prior art ballast. Further, to handle the large current, the wire used is typically “litz” wire (also known as Litzendraht wire), which is wire made from a number of fine, separately-insulated strands specially braided or woven together for reduced skin effect and hence lower resistance to high frequency currents for lower RF losses. The inductor's rating is largely determined by the higher frequency operation and can be sized roughly by the following formula: 30/watts=X mH, where “watts” denotes the desired output from the light source. The inductor value must be such that it allows the circuit function to operate within the desired frequency range (18-80 kHz) and preferably above 40 kHz in order to meet certain energy efficiency standards. Thus, one rule of thumb is that a 15 watt light source would typically require a 30/15=2 mH inductor. Further, the value of the inductance varies with the frequency of operation desired according to equation (1) below. Thus, a variety of values can be used which range up to 3 times the resultant inductance or ⅓ of the above result, that is, the range could be as low as ⅔ mH to as high as 6 mH. As the resonant frequency of the tank circuit is increased, the inductance value of the inductor is lowered. FIG. 10a-c shows the dimensions of a portion of a typical inductor core, wherein a side view of the inductor 1000a is shown in FIG. 10a, an end view 1000b is shown in FIG. 10b. The inductor 1002, comprising a “double E” core 1004a, 1004b is shown in FIG. 10c. The following values that could be typically used for a range of power output up to 38 watts at 40 kHz, wherein A=1″, B=0.63″, C=0.25″, D=0.507″, E=0.74″, F=0.25″ and the gap is between 0.1 and 0.3″ but could be as high as 0.5″. Those skilled in the art will recognize that a variety of shapes, wire, material, and configurations are possible in order to meet the functional requirements of the inductor.

The inductor 444 is connected to the second node 214 via a capacitor 446 to store a charge therein and excite the light source. Further, the inductor insures that the current is in phase with the supply voltage, thereby contributing to the high power factor of the circuit. Further still, the inductor 444 is connected to a capacitor 448 via the first filament 255. The capacitor 448 is also connected to the second node 214 via the second filament 260. The capacitor 448 receives current and stores a charge therein to excite the light source via current flowing across the filaments 255 and 260. The resonant frequency of the example resonant circuit 245 is described by equation 1 below:

$${f}_{R} = \frac{1}{2 π \sqrt{\frac{{L}_{444} {C}_{442} ( {C}_{446} + {C}_{448} )}{( {C}_{442} + {C}_{446} + {C}_{448} )}}} \qquad Equation [ 1 ]$$

where f_{R} is the resonant frequency of the circuit, L₄₄₄ is the inductance value of the inductor 444, C₄₄₂ is the capacitance value of the capacitor 442, C446 is the capacitance value of the capacitor 446, and C₄₄₈ is the capacitance value of the capacitor 448. In the illustrated embodiment, the capacitor 446 is configured to have a different value such that it has a different energy potential than the capacitor 448. In particular, the capacitor 446 provides a larger voltage to allow the lamp 250 (FIG. 2) to turn on. The summation of capacitor 446 and capacitor 448 impacts the resonant frequency of the tank circuit. Typically, the value of capacitor 448 is determined by the desired current flow through the filaments, which have a resistance typically set by the manufacturer or by an industry standards body for a particular country. Typically, capacitor 215, capacitor 442, and capacitor 446 are made from polypropylene, but could be made from polyester, providing each has a low equivalent series resistance (ESR) value. These capacitors typically can not be electrolytic capacitors, because electrolytic capacitors generally have large ESR characteristics.

The values of the components in the circuit vary on the output power of the lamp and the desired resonant frequency. In certain embodiments, values for 120 VAC operation of certain components are illustrated in the table below:

| | | | | | Inductor | |
|---|---|---|---|---|---|---|
| | | | | | (typically | |
| Embod- | Output | Capacitor | Capacitor | Capacitor | 0.034 | Freq. |
| iment | Power | 442 | 446 | 448 | litz wire) | (kHz) |
| 1 | 42 W | 0.047 μF | 15 nF | 8.2 nF | .72 mH | 47 |
| 2 | 32 W | 0.1 μF | 37 nF | 15 nF | .901 mH | 27 |
| 3 | 15 W | 0.1 μF | 12 nF | 10 nF | 1.672 mH | 30 |

In embodiment 1 and 3, the operation is for a CFL bulb, whereas embodiment 2 is for a pair of 4 foot tubular lamp bulbs. For embodiments 1, and 2, the inductor can be made from an Elna bobbin part # CPH-E34/14/9-1S-12PD-Z. For embodiment 3, the inductor can be made from an Elna/Fair-Rite core #9478375002. In the above embodiments, it is possible to use a 1 μF capacitor for output powers of 15-42 watts.

The other values of the circuit shown in FIG. 4a are summarized as follows:

| | |
|---|---|
| Driver 428 | IR Corp IR2153 or IR2153D |
| Transistors 235, 240 | N FET 250 v, 0.47 Ohm |
| Capacitor 215 | 1 μF 250 v, polypropelene |
| Diodes 406, 403, 408, 404, 424 | 1 A, 400 v general purpose diode, |
| | 1N4004 |
| Diode 430 | 1 A, 400 v fast diode, 1NF4004 |
| Transistor 416 | 2N2222 |
| Capacitor 432 | 1 μF 25 v, electrolytic |
| Capacitor 426 | 22 μF 25 v, electrolytic |
| Resistor 412 | 220 Ohm |
| Resistor 414 | 1 M Ohm |
| Resistor 422, 421 | 1k Ohm |
| Diode 418 | 14 v, 10%, 200 mW, Zener |
| Resistor 436 | 50k potentiometer |
| Capacitor 434 | 220 pF, mica |

Those skilled in the art will realize that other values or type of components may be used.

The embodiment of FIG. 4a is suitable for operation with a dimmer, due to the presence of the voltage regulator circuit 220. Because the voltage present on node 212 is an unfiltered, rectified AC voltage (e.g., DC), the voltage has a periodic valley of zero volts. A typical half cycle rectified voltage wave form 472 that is present at node 212 is shown in FIG. 4c. At the time that the DC voltage is zero at node 212, the voltage regulator circuit 220 ensures that a stable DC output voltage is nevertheless provided to the driver circuit 225.

When operated with a dimmer, the voltage provided to the ballast circuit may not be that as shown as waveform 472 in FIG. 4c. When operating, a dimmer typically clamps a portion of the waveform to zero for a defined time period. This time period is determined in part by the user turning a potentiometer in the dimmer to effect different dimming levels. Thus, in one instance, the time may be set at t₁ 470 as shown in FIG. 4c. The resulting voltage wave form 474 has the portion prior to t₁ clamped to zero, so that the resulting waveform has a period of time where the input supply voltage to the ballast is zero. The shaded portion under the wave 474 represents the energy provided to the ballast, and the less energy provided to the ballast, the less light produced by the light source.

Thus, during the time period up to t₁ the voltage regulator circuit 220 ensures that the driver circuit still receives a DC operating voltage. If, however, the ballast circuit is never used with a dimmer (or the dimmer itself is never used), then the voltage waveform similar to 474 would never occur, and the voltage at node 212 would always look like waveform 472.

In such cases, the voltage regulator circuit 220 can be simplified to the embodiment shown in FIG. 4d. In FIG. 4d the voltage regulator circuit comprises three components, capacitor 426, resistor 485, and diode 495. In this embodiment, the resistor is typically a 47 k-90K ohm value and provides a sufficient average voltage to the driver circuit 428. It may be necessary to utilize a version of the driver circuit 428 which has an internal zener diode providing protection from over-voltages as well as using a series diode that is added with the regulated version of the driver circuit. When the voltage at node 212 is less than the required Vcc voltage, the capacitor 426 discharges, providing the necessary voltage to drive the circuit 428. The diode 495 prevents the charge in the capacitor 426 from discharging through resistor 485. This diode is optional, depending on the desired speed of light activation of the bulb. However, in this embodiment, capacitor 426 may not be charged fast enough to provide the necessary voltage when a dimmer is used, due to the clamping of the input voltage by the dimmer. However, this embodiment provides a high power factor ballast which, although not dimmable, provides many benefits.

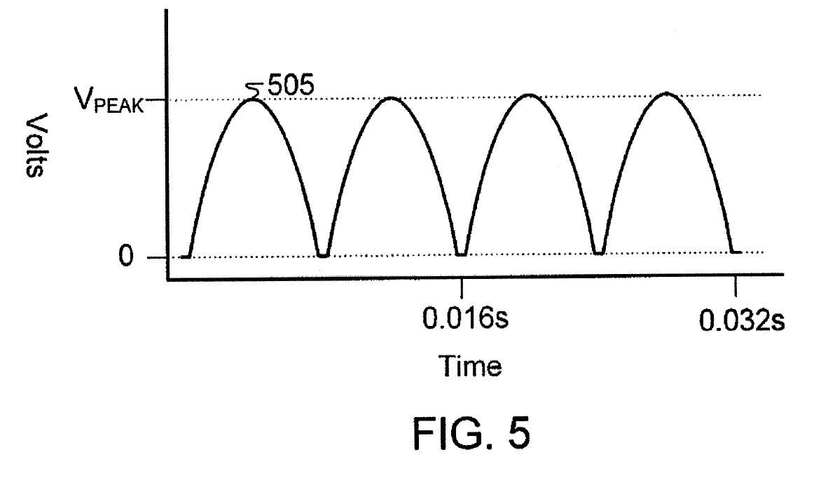

The operation of the example of FIG. 4a will be explained in conjunction with FIGS. 5-9, which illustrate the operation of the circuit 400. As described above, the rectifier circuit 210 rectifies the current provided via the power source 205, thereby creating a voltage waveform at 120 Hz. The exemplary waveform of FIG. 5 illustrates the voltage differential between the first node 212 and the second node 214, which is denoted by the reference numeral 505. As seen, the waveform valleys go to zero or near zero (less than 10-18 volts), because as mentioned previously, capacitor 215 presents a large impedance to the line frequency of the power source 205 and does not substantially affect the rectified alternating current (DC) at the nodes 212 and 214. Consequently, the voltage at node 212 dips from a peak voltage to essentially zero volts each half cycle. The value of capacitor 215 should not significantly impact the low frequency output voltage waveform of the rectifier.

In addition, the line filter 401 is configured to prevent high frequency energy from the capacitor 215 from entering back into the power source 205. The filter 401 is not required to be present in commercial products embodying the invention, but typically a filter circuit of some form is included when the ballast is designed to power 40 watt or higher fluorescent lamps. As shown in FIG. 4b, the line filter may comprise other components, such as a fusible link 464 and a transient suppressor 466 (which although not required for filtering purposes, may be present nevertheless). The filter includes capacitor 462 across in the input mains, and chokes 460a and 460b in series with the input mains. The capacitor is typically 0.1 μF and each choke is typically 190 μH. This line filter attenuates the high frequency signals generated by the ballast from being introduced back into the power source. The transient suppressor is shown as part of the line filter, but it protects transient voltage spikes from the power source. A resistor 465 may be incorporated in addition to the filter 401, which is effective for absorbing energy that may facilitate dimming of the ballast for certain applications. If the resistor is present, a 30 ohm, 5 watt value may be used for a 10 watt CFL.

Returning to FIG. 4a, the operation of the voltage regulator 220 and resistor 414 causes the NMOS transistor 410 to have a gate-source voltage and, in response, it turns onto conduct current. In the illustrated example, the resistor 412 generally configures the transistor 410 to operate in the safe operating area and in the event of excessive current flow, it experiences a failure thereby uncoupling the transistor 410 from the node 212. Initially, the zener diode 418 conducts current into the base of transistor 416 causing the NMOS transistor 410 to block current from flowing into the second node 214 by presenting a large impedance of transistor 410, which causes the current to flow toward the gate drive supply voltage (Vcc) on pin 1 of the driver circuit 428. When current flows toward the gate drive supply voltage, the capacitor 426 stores the current energy as a voltage to provide a substantially constant voltage to the driver circuit 428. As a result, the driver circuit 428 turns on and produces pulses via its respective outputs at a frequency determined by the resistance value of the adjustable resistor 436 and the capacitance value of the capacitor 434. In some embodiments, the adjustable resistor may be connected to another resistance in series (typically around 33 k), to avoid a condition where the adjustable resistor is set to zero (or a very low) resistance, thereby potentially damaging the driver integrated circuit. In other embodiments, the adjustable resistor can be set during manufacturing in order to adapt imprecise component values in the resonant circuit and set the switching frequency of the transistors. In other embodiments, the adjustable resistor 436 can be a fixed value resistor or equivalent depending on the desired operating frequency.

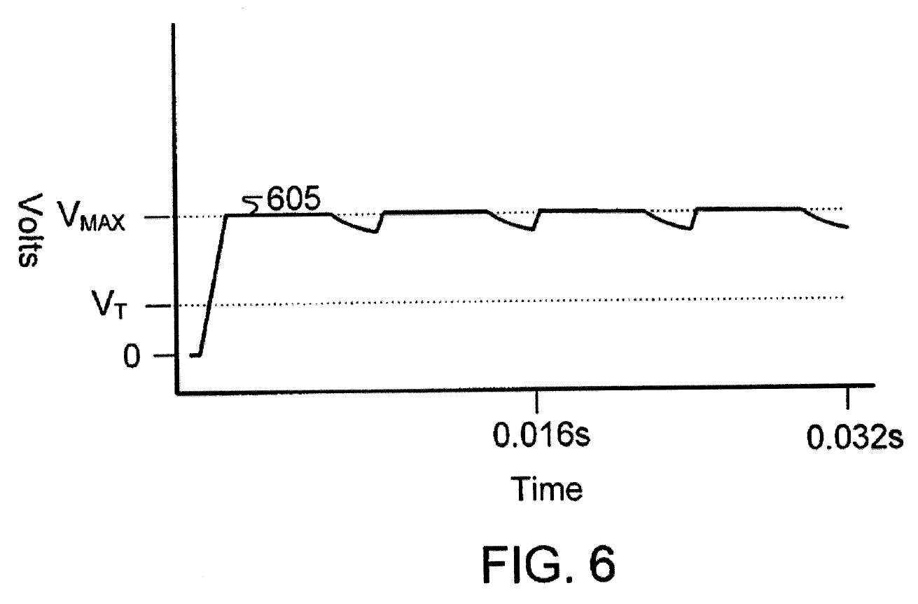

However, when the voltage across the zener diode 418 exceeds a corresponding breakdown voltage (e.g., about −14.0 volts, etc.), the zener diode 418 enters what is commonly referred to as “avalanche breakdown mode” and allows current to flow from its cathode to its anode. In response, the current flows across the resistor 420 and causes the transistor 416 to have a base-emitter voltage (V_{BE}), thereby turning on the transistor 416. The transistor 416 sinks current into the second node 214, which reduces the gate-source voltage of the NMOS transistor 410 and the current through the zener diode 418. Once the current in the zener diode 418 does not exceed the design of the output of the regulator value, the zener diode 418 recovers to the design value and reduces the current from flowing into the resistor 420. That is, as illustrated in the example of FIG. 6, by reducing the voltage at the source of the NMOS transistor 410 denoted by reference numeral 605, the voltage supplied to the driver circuit 428 does not substantially exceed the predetermined threshold voltage (Vₘₐₓ). In the example of FIG. 4, the resistance value of the resistor 422 is selected to reduce the loop gain of the transistor 416 to prevent oscillations and the resistance value of the resistor 420 is selected to prevent a leakage current from flowing via the zener diode 418 into the base of transistor 416.

Thus, the example voltage regulator 220 is configured to provide a substantially constant (i.e., regulated) voltage to the driver 225. When the rectified voltage provided via the rectifier 210 falls below a predetermined threshold voltage (V_{T}), the voltage output by the voltage regulator 220 decreases. However, as illustrated in the example of FIG. 6, the energy storage device 426 has a corresponding voltage that exceeds a minimum threshold voltage (V_{T}) and continues to provide energy to the driver circuit 428. In addition, when the voltage at the node 212 falls below the voltage of the regulator 120, the diode 424 prevents current from flowing backwards from the capacitor 426 into the NMOS transistor 410 and resistor 412 from the constantly discharged tank circuit via 212.

The driver circuit 428 is configured to generate a signal that alternately actuates one of the transistors 235 and 240 at the switching frequency, which is much higher than the line frequency. In particular, during the first half (or a portion thereof) of a single cycle of the switching frequency, the high side output (HO) of the driver circuit 428 produces a high side pulse to turn on transistor 235 while transistor 240 is turned off. Typically, the high side pulse has a duration that does not exceed half of the time period of a cycle of the switching frequency. When the driver circuit 428 turns on transistor 235, the transistor 235 couples the node 212 to the resonant circuit 245 via a low impedance path.

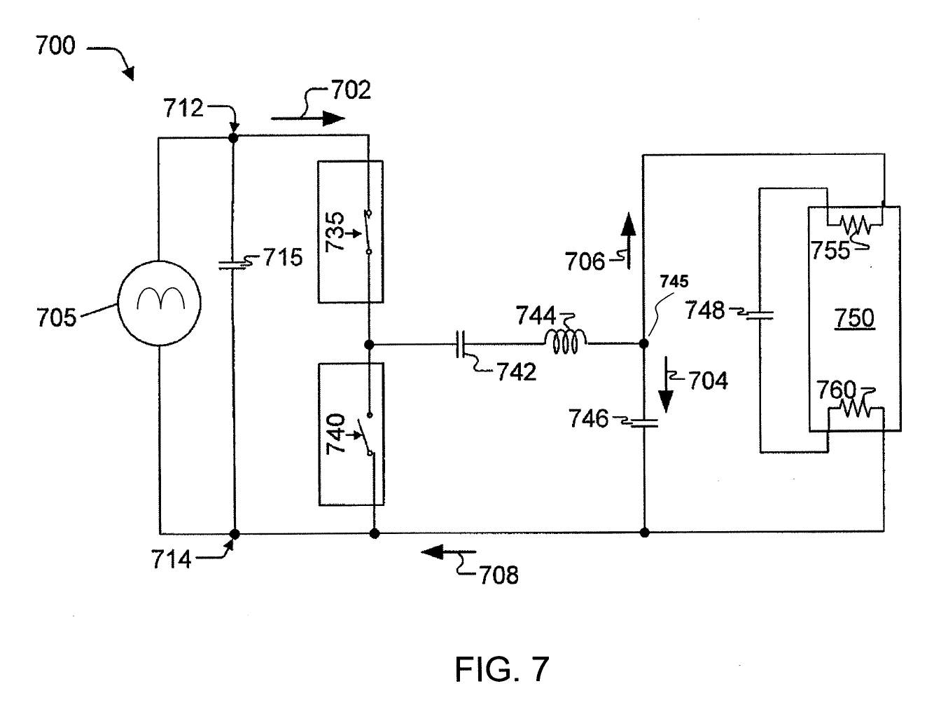

The example of FIG. 7 illustrates an equivalent circuit 700 of a ballast circuit 400 of FIG. 4a. In this illustration, a rectified AC voltage (e.g., a time varying DC voltage waveform where each waveform is half of a sine wave) is represented as an unfiltered rectified power source 705, which produces a waveform similar to that shown in FIG. 5. Initially, energy represented by a current denoted by reference numeral 702 flows from the power source 705 and the capacitor 715 and into the resonant circuit because the transistor 740 is turned off. The current 702 includes both current based on (twice) the line frequency (2*60 Hz=120 Hz) and high frequency current (e.g., 20 kHz). In the example of FIG. 7, the capacitor 742 presents a high impedance to the low frequency current, thereby shaping the line frequency current flowing into the inductor 744. As the current leaves the inductor 744, a current denoted by reference numeral 704 having the high frequency current flows into the capacitor 746, which stores a portion of the current as a voltage. In addition, a current having the line frequency current and the high frequency current denoted by reference numeral 706 flows into the filament 755 and a portion of current is stored in capacitor 748 as a voltage. When this process occurs at the beginning of the half cycle of the rectified AC voltage, there is not enough voltage present on the bulb to cause ionization and light to be generated. However, as the input voltage at node 712 increases, and the energy stored in the resonant circuit also increases, the voltage across the light source 750 quickly increases to a point where the voltage is sufficient to initiate ionization and maintain the generation of the light at the light source 750. When this, occurs, then as a result of the line current and the high frequency current in the light source 750, the light source 750 emits a light that is generally visually perceptible. In addition, the line frequency current and a portion of the high frequency current, which are denoted by reference numeral 708 in the illustrated example, leaves the resonant circuit 245 and returns to the power source 705 and capacitor 715. Slightly before the end of the first half cycle at the switching frequency, the energy stored in capacitor 715 is discharged to its lowest level. Because the transistors operate above the tank circuit's resonant frequency, the transistor switches at zero or near zero current levels.

During the second half of the time period of the switching frequency, the low side output (LO) of the driver circuit 428 produces a low side pulse to turn on the transistor 240 just after transistor 235 is turned off. When the driver circuit 428 turns on the transistor 240, the transistor 240 couples the node 214 to the resonant circuit 245 via a low impedance path. The second pulse generally has a duration that is less than 50% of the time period of the switching frequency (e.g., less than a half-cycle).

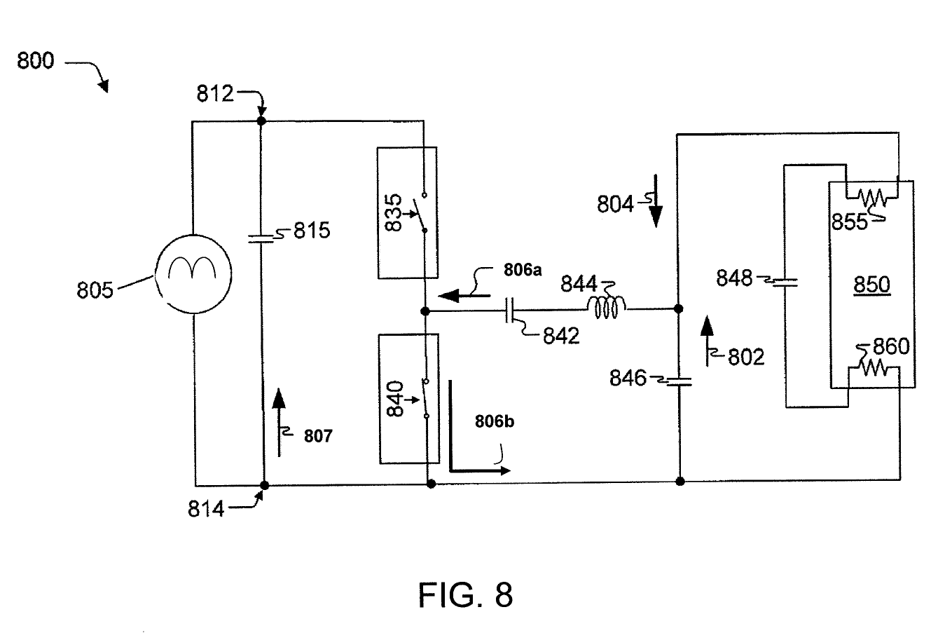

The example of FIG. 8 illustrates an equivalent circuit 800 of the ballast circuit 400 (FIG. 4) when the switch 840 is closed. Two simultaneous events are occurring. First, a low frequency current 807 is continuously charging capacitor 815. Recall that capacitor 815 is discharged to its lowest point after switch 835 has closed. After switch 835 is opened, capacitor 815 is no longer discharging, and is recharged by the unfiltered rectified voltage from source 805. Second, when switch 840 is closed, there is no current flowing and no energy stored in the inductor. Once switch 840 is closed, the capacitors in the resonant circuit discharge, generating a current. The flow of current 806a when the transistor 840 couples the node 814 to the resonant circuit is the sum of the currents 802 and 804 (which is from the charge in capacitors 846 and 848). Capacitor 842 stores an additional charge compared to capacitors 846 and 848 based on the low frequency current which previously flowed through it, that is not clamped by the bulb. Current 806a flows through the switch 840 back into the resonant circuit as shown by 806b. Thus, the energy in the resonant circuit is recirculated. At the same time, the voltage across the inductor and capacitors 846 and 848 changes polarity, and this causes the voltage across the light source 750 to experience a negative “mirror” of the voltage present in the prior switching half cycle.

As described above, by turning on the transistor 840, the resonant circuit is connected to the second node 814 via a low impedance path. In response, the capacitors 842, 846 and 848 discharge the voltage therein as currents denoted by reference numerals 806a, 802 and 804, respectively. The currents 802 and 804 flow into the inductor 844 and charge the capacitor 842 as a voltage, thereby causing the resonant circuit 245 to have a negative voltage with respect to the second node 814. As a result of current leaving the capacitors 846 and 848, the light source 850 is actuated to visually emit light. After a delay, the capacitor 842 discharges producing a current as denoted by reference numeral 806, which flows into the node 814. At the end of the second half cycle of the carrier frequency, the resonant circuit stores substantially no energy and all the energy is stored in the inductor, with very little, if any, current flowing. Thus, the driver circuit is continually driving switches 835 and 840 even when there is no current flowing through the switches.

Thus, in FIG. 7, when switch 735 is closed, the resonant circuit is energized both from the line voltage (unfiltered DC voltage) and the small energy in capacitor 715, which is added to the energy already stored in the resonant circuit. Then, in the next half of the switching cycle, in FIG. 8, switch 835 is opened, and switched 840 is closed. The capacitors in the resonant circuit discharge, causing the voltage to become negative across the bulb. Assuming the bulb has been ionized, the bulb functions as a voltage regulator to limit the maximum absolute voltage that can exist across its terminals. During bulb ionization, current 802 is largely constant, and current 804 is varying with the AC input line current. It should be noted that this description is in terms of a single switching cycle at a high frequency, and that the process is repeated for other switching cycles wherein the input voltage from the power source may be at a lower or higher voltage, thereby impacting the relative charges, voltages, and currents of the various elements in the circuit.

The illustrated voltage waveform of FIG. 9 illustrates the voltage in the resonant circuit across the light source during operation. FIG. 9 illustrates a number of half line cycles (120 Hz), wherein a given half cycle A 906 is half the line frequency (e.g., 120 Hz or 0.008 seconds). At this time scale shown in FIG. 9, the individual voltages 901 at the switching frequency (e.g., 40 kHz) are difficult to identify individually, and the figure is not necessarily drawn to scale. (If drawn to scale, the high switching frequency waveforms would be indistinguishable).

Each half line cycle in time period A 906 shows a similar pattern. In time period B 900, which occurs at the beginning of the half cycle, the switch 735 of FIG. 7 introduces energy from the rectified AC line. However, because the rectified AC voltage is just increasing from zero volts, the energy introduced into the resonant circuit is relatively small. Further, any energy stored in bypass capacitor 715 is added as well into the resonant circuit. The energy is stored as a voltage in the capacitors of the resonant circuit. Because of the cumulative aspect of energy stored in resonant circuit, the voltage across the light source increases faster than the increase in the rectified AC voltage. Then switch 735 opens, and shortly thereafter switch 740 closed, which is depicted in FIG. 8. At this point, the energy is converted into the inductor from the capacitors and back into the capacitors at a reversed polarity and the voltage across the bulb is reversed. During a short time period B 900 in FIG. 9, the voltage rapidly increases in the unloaded resonant circuit because the tube has not ionized. No ionization occurs in the tube, and while there may be some continued light generated by phosphoresce in the tube, there is no active ionization occurring to generate light.

This process builds up voltage across the tube until ionization occurs (around 20-35 volts of the input voltage to the resonant circuit), which occurs at the beginning of time period C 902. The tube acts as a voltage clamping regulator to keep the voltage constant across it (that is, the magnitude or absolute value of the voltage, recognizing it is either positive or negative in value), which is shown as an average ionization voltage level 910 in FIG. 9. This process continues for much of the remainder of the half-cycle, until the unfiltered DC input voltage to the resonant circuit decreases below a point where ionization is no longer maintained. This is shown as time period D 904. Thus, before ionization, all the energy in the resonant circuit is circulated, and after ionization, most of the energy in the resonant circuit is circulated (because a portion is transferred to the bulb for generating light).

The voltage change over the beginning, peak and falling voltage edges of the rectified AC input to the tank (which is switched by transistors 735 and 740) and the constant ionization voltage of the bulb causes a large change in current to be linearly processed by capacitor 742 and inductor 744. As compared to a traditional ballast with a filtered DC supply, this change in current causes a large change in Q.

Thus, there is short time period at the beginning of a half cycle and the end of the half cycle shown as period E 908, where ionization does not occur in the tube, and there is no light generated as a result of ionization. Consequently, unlike the prior art which initiates ionization in the tube and maintains the ionization during normal operation (e.g., while power is applied to the ballast), the present invention causes ionization to initiate every half cycle, or 120 time per second. Further, there is a time period every half cycle where light due to ionization stops and is not generated. However, the time period when the voltage is too low to generate ionization is very short, and does not create a perceptible condition for humans.

The current flowing into the resonant circuit at the line frequency is largely maintained as a sine wave, which means that the current load is largely in phase with the voltage at the line frequency from the power source. Further, the resonant circuit does not store any significant energy (inductive or capacitive) to distort the low frequency current during the time period between the half cycles, thereby causing the resonant circuit to appear as a resistive load to the power supply. Thus, the present circuit maintains a high power factor during operation. In particular, because the current flowing through the resonant circuit is substantially similar to a sine wave, the crest factor of the illustrated example is approximately the square root of 2 (e.g., about 1.5), which close to an ideal crest factor. Contrast this to the prior art ballasts which require a dedicated power factor correction circuit to obtain a suitable crest factor.

In addition, the example ballast circuit of present invention does not require a large electrolytic capacitor as used in conventional ballasts to store substantial amounts of low frequency energy because the high frequency energy is continually recycled by a non-electrolytic bypass capacitor. Further, the impedance presented to the power source 205 is modified only by the resonant circuit and the example circuit 400 contains only a single inductor. As a result, the embodiments described herein are able to realize a high power factor (typically above 0.9) with a single stage of processing with respect to the power source without incorporating the components found in a traditional power factor correction circuit. In addition, because the described examples do not require a large, high voltage, low temperature electrolytic capacitor, the lifespan of ballasts of the present invention is substantially increased.

Other benefits of the invention include the ability to effectively dim the light source over a predictable and wider range. Although the ballast itself does not provide any dimming and requires interaction with a dimmer circuit to do so, the ballast circuit can be effectively used with the dimmer disclosed in U.S. patent application Ser. No. 12/205,564 filed on Sep. 5, 2008, which in turn claims the benefit under 35 U.S.C. § 119(e) to U.S. Provisional Patent Application entitled “Two-Wire Dimmer Switch for Dimmable Fluorescent Lights” filed on Feb. 8, 2008, bearing Ser. No. 61/006,967, both of which are herein incorporated by reference for all that each teaches. The charging of the housekeeping electrolytic capacitor in the voltage regulator is performed at the very beginning of the voltage waveform produced from the output from the dimmer which dissipates the stored inductance in the house wiring created when the phase controlled dimmer has turned on charging the input bypass capacitor of the ballast. This would normally cause a ringing of current of the input bypass capacitor if it were not damped by the load presented by the series regulator at this precise time during the charging of the house keeping capacitor.

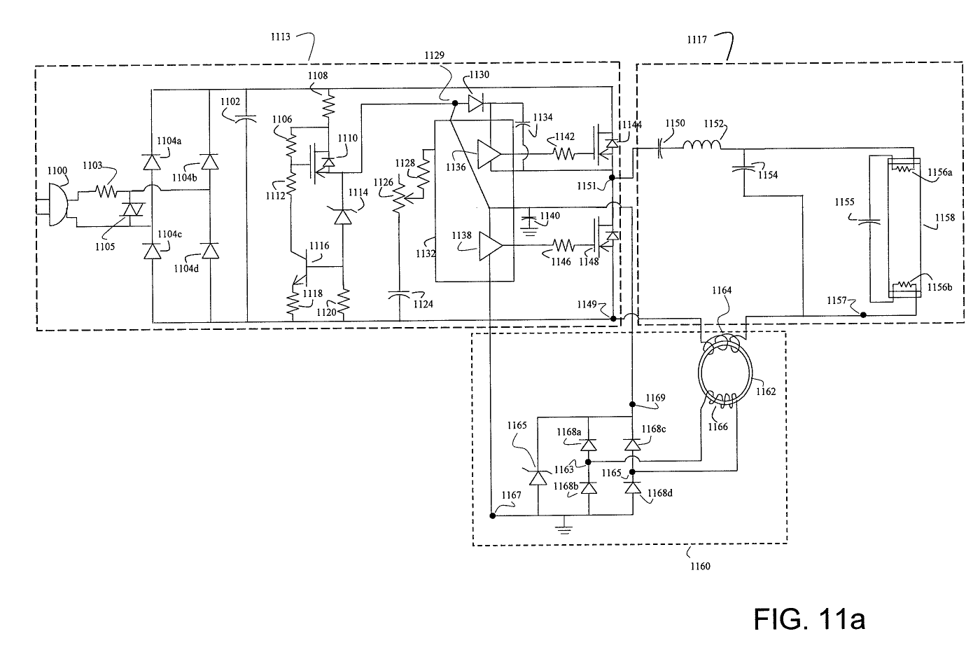

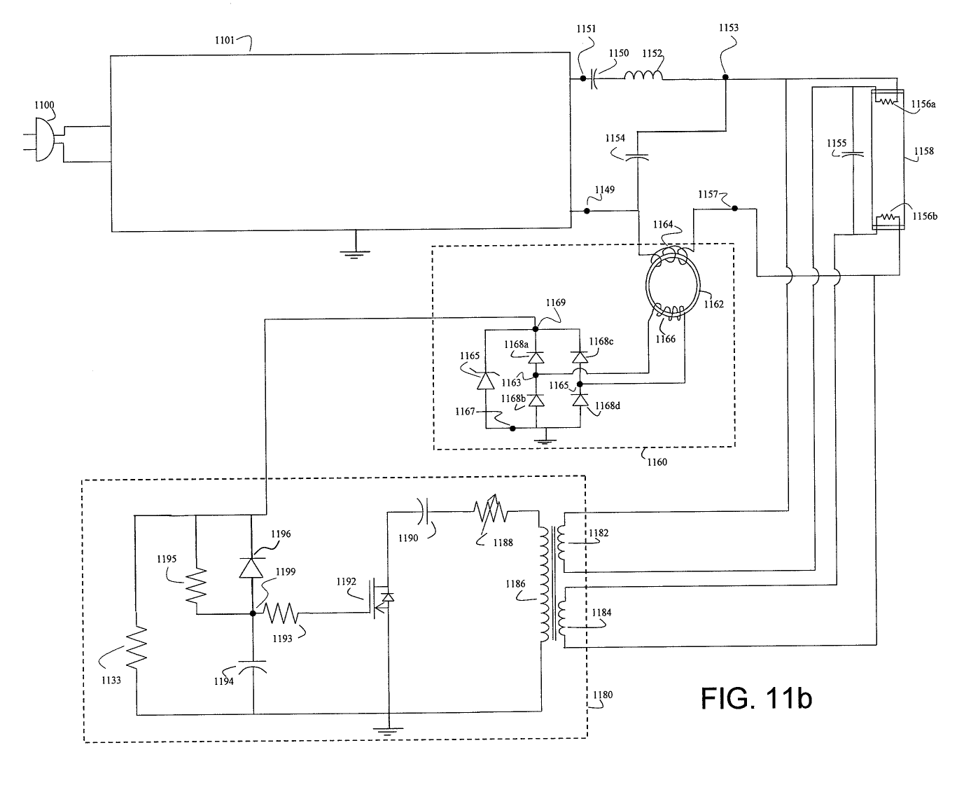

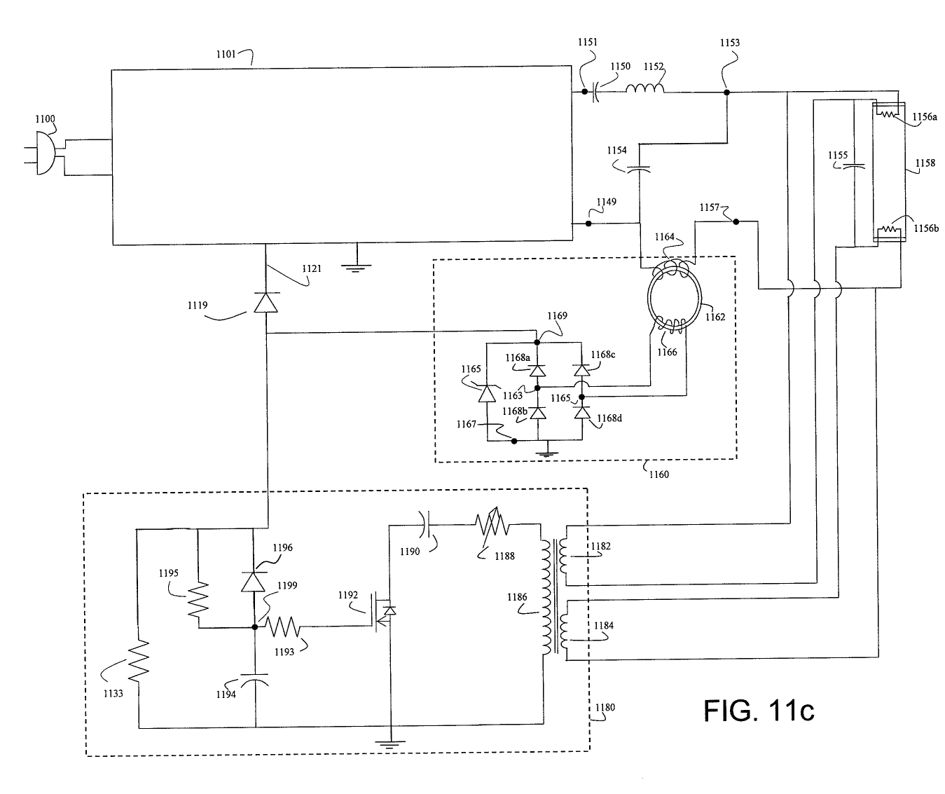

FIG. 11a illustrates another embodiment of the energy efficient ballast circuit incorporating further energy savings circuitry. In this embodiment, additional circuitry is added that shuts off the linear voltage regulator in the ballast after the initial startup. Recall previously from the discussion of FIG. 4d that the voltage regulator circuitry provides power to the integrated circuit driver chip. Ballasts may incorporate a voltage regulator for various reasons, such as to power integrated circuits used for other functions, such as power factor correction.

Using this type of voltage regulator in a ballast is more efficient than using a series resistor connected to the voltage source, because voltage regulators only draw the amount of current needed. Unlike a series resistor, which must be designed to accommodate lower voltages on power lines, a voltage regulator adapts the needed current to the input voltage. In such cases, the voltage regulator facilitates start up, but it is not the most efficient power source during normal operation of the ballast (e.g., after the bulbs are ionized), the housekeeping supply power required from the voltage regular is typically very low. In some embodiments, the current may be as low as 20 mA at 12 volts, which is 240 mW. Obviously, these current/voltage values are dependent on various factors, including the oscillation frequency of the ballast, the ratings of the transistors in order to accommodate different bulb sizes, etc. A voltage regulator may have to dissipate almost 2.4 W to generate a housekeeping power of 240 mW. This illustrates the high level of wasted energy necessary for the voltage regulator to produce the housekeeping energy during steady state operation. Consequently, the efficiency of ballasts incorporating a voltage regulator can be still improved after steady state operation is achieved. While the voltage regular facilitates operation start up, its efficiency is not as efficient as it could be.

The embodiment in FIG. 11a can be viewed as having three main portions, namely: a portion of ballast circuitry 1113, a resonant tank circuit 1117, and a feedback circuit 1160. In this embodiment, the ballast circuit 1113 represents a portion of the total circuitry of the ballast, as the entire ballast includes the tank circuit. This portion of the ballast circuit 1113 is identified separately herein for convenience.

The operation of the ballast circuit 1113 is as described earlier. To recap, power from plug 1100 is provided to an optional filter resistor 1103 and surge suppressor 1105. From there, power is provided to a full wave bridge comprising diodes 1104a-1104d. The bypass capacitor 1102 functions as previously described, along with a voltage regulator comprising components 1106-1114. The driver circuit comprises an integrated circuit 1132, which illustrates the individual drivers 1136 and 1138 contained therein. In this embodiment, power to the integrated circuit is shown by line connected to node 1129. The outputs of the drivers are provided to FETs 1144 and 1148. The description of the function and operation of all the components in the ballast circuitry 1113 are not repeated as they have been discussed previously, and their function is discernable to one skilled in the art.

The tank circuit comprises capacitor 1150, inductor 1152, capacitor 1154, capacitor 1155, and bulb 1158, which has filaments 1156a and 1156b. Note that in some embodiments, the value of capacitor 1154 may be incorporated into capacitor 1155, and thus, capacitor 1154 is optional, e.g., it may not be present as a discrete element in the tank circuit.

Finally, the feedback circuit 1160 in one embodiment comprises a transformer 1162 which has a primary winding 1164 and a secondary winding 1166. The primary winding has a current passing through it which generates an alternating voltage at the output of the secondary winding. The secondary winding is connected to a full wave bridge comprising four diodes 1168a-1168d configured as shown. An output voltage (referred to herein as a signal voltage) typically around 12-14 volts is provided from the feedback circuit at node 1169. A zener diode 1165 may be present to prevent unsafe transient voltages from existing on the output of the full wave bridge.

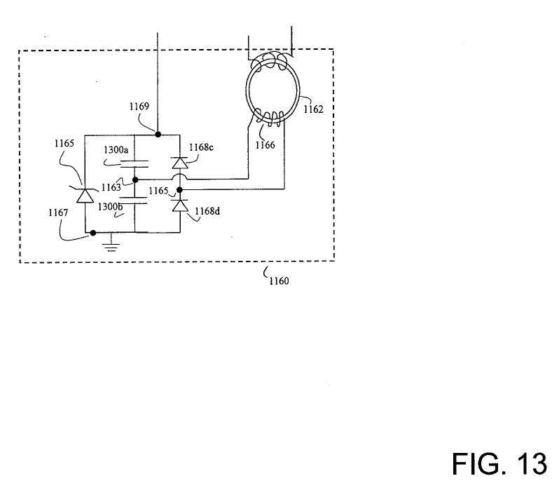

Other embodiments of the feedback circuit may exist, which generate a signal voltage, such as shown in FIG. 13. In this embodiment, two capacitors 1300a and 1300b, are configured in series in the circuit. These capacitors function as a voltage doubler, with the output voltage still provided at node 1169. The capacitors may have a 0.1 μF value, but other values may be used. In other embodiments, the transformer may be replaced with an inductor having a primary winding in the tank circuit and a secondary winding providing the appropriate voltage output. A current transformer capable of providing the appropriate voltage output, or otherwise adapted to generate the appropriate signal voltage could be used as well. Thus a variety of structures can be used to detect a current in the tank circuit and generated a signal voltage in response.

In this embodiment (FIG. 11a), the capacitor 1154 has a terminal connected to node 1157 (to the right of the primary winding 1164). In this embodiment the inductance of the primary winding 1164 is added to the inductance of inductor 1152. This configuration increases efficiency. In the embodiment shown in FIG. 11a, even if there is no tube present in the ballast, there would be current flowing through the primary winding of the transformer 1164. Thus, as will be seen, this configuration results in deactivating the voltage regulator when there is no bulb connected to the ballast. In other embodiments, the terminal of capacitor 1154 can be connected to node 1149 (to the left side of the primary winding 1164) and is in fact a preferred configuration when the filament shutoff circuitry discussed below is also present. However, in that case (when the capacitor terminal is connected to 1149), the feedback circuit 1160 does not shut off the voltage regulator when there is no tube located in the ballast because there can be no current flowing through primary winding 1164 when no tube is present.

At startup, there is a current in the tank circuit at node 1157 which comprises 1) a current flowing through filaments 1156a, 1156b, and capacitor 1155, and 2) a current flow through the bulb, e.g., from filament 1156b to filament 1156a. Note that the use of “to” and “from” represents a point in time during the high frequency switching cycle, and the current alternates direction from one half cycle to the next half cycle. During steady state operation (e.g., after the bulb have ionized), the current flowing through node 1157 is detected by transformer 1162. Specifically, the current passing through the primary winding 1164 induces a current in the secondary winding 1166. The primary winding can be thought of as a transformer with the primary winding being inserted in series between node 1149 and 1157 such that the current in the tank circuit during normal operation passes through the primary winding.

In one embodiment, the primary winding has 7 turns wherein the secondary winding has 35 turns. Typically, the ratio of turns on the primary to secondary is 1:5 for a 20 W bulb, and a higher ratio typically is used for greater wattages and vice versa. Although the inductance of the transformer is in series in the inductor 1152 of the tank circuit (and thus is added to the inductance of inductor 1152 to form the total inductance of the tank circuit), the inductance of the primary winding is a small enough value that its inductance does not significantly alter the characteristics of the tank circuit.

In operation, a voltage is induced in the secondary winding and provided to the full wave bridge, comprising 1N4148 diodes, which causes a voltage to be present across nodes 1169 and 1167. The voltage (a signal voltage indicating the tank circuit is operating and that a tube is present) at node 1169 is provided to node 1129 of the ballast circuit 1113. There, the voltage provides power to the input of the integrated circuit driver 1132 so that the integrated circuit remains functional after the voltage regulator is deactivated. At the same time, the voltage from the full wave bridge is also provided both to the gate of the FET 1110 in the voltage regulator and to the cathode of zener diode 1114. Because the output voltage from the full wave bridge (about 14 volts) exceeds the breakdown voltage of the zener diode 1114 (12.5 volts), the output voltage effectively causes the voltage regulator to shut down. When the voltage at the cathode of zener diode 1114 exceeds the breakdown voltage (by about 2 volts), the current passing through the zener diode causes the voltage at resistor 1120 to increase. This, in turn, causes the gate of transistor 1116 to turn ON. Turing transistor 1116 ON causes the collector of transistor 1116 to be connected via resistor 1118 to ground, which reduces the voltage at the gate of FET 1110, turning the FET OFF. Thus, no current into node 1129 is provided by the voltage regulator circuit and the voltage regulator is considered deactivated.

In summary, once current is detected by the feedback circuit in the tank circuit, a voltage is generated that causes the voltage regulator to shut down. Further, the same voltage is provided to the integrated circuit to continue powering it. In this manner, a more efficient powering of the integrated circuit occurs by incorporating the feedback circuitry 1160.

As evidenced from FIG. 13, there are other embodiments of the feedback circuit, and a variety of structures can be used to implement the function of providing a signal when the tank circuit is operational. Preferably, this includes detecting the presence of the bulb in the tank circuit. Those skilled in the art will recognize that other types of feedback circuits can be made that perform the same function.

The feedback circuitry 1160 can be adapted in other ways to save energy in ballasts. In many conventional ballasts, a current is provided to the bulb filaments at start-up so as to heat the filaments. When the filaments are heated, it reduces the ionization voltage of the bulbs and facilitates ionization. However, once ionized, the filament current is not required to maintain ionization, but it may be provided nevertheless. Thus, the feedback circuitry provides the output voltage to a filament shutoff circuit that removes the current flowing through the filaments after the bulbs have ionized. Terminating the current flow through the filaments after the bulbs have ionized saves energy and increases the efficiency of the ballast

One embodiment of the filament shutoff circuitry is shown in FIG. 11b. This embodiment is of a current fed filament. In this embodiment, the portion of the ballast circuit 1101 is not shown, and can be of various configurations, and is not required to incorporate the aforementioned voltage regulator. The filament shutoff circuitry 1180 receives a voltage signal from node 1169 of the feedback circuit 1160. The voltage to resistor 1195 and capacitor 1194 causes a time-increasing voltage to appear at node 1199. As the voltage at node 1199 increases, it is presented to the gate of FET 1192 causing the FET 1192 to turn ON. The time required for the voltage at node 1199 to reach to turn the FET ON depends on the RC value of resistor 1195 and capacitor 1194, and typically is set from a few seconds to a few minutes. This time delay after the bulbs are turned on until the filament circuit turns off the filament current.

While the bulb is on (ionized), the windings 1182 and 1184 charge up the capacitor 1190, to the peak voltage of winding 1186. After it is charged, there is no current passing through capacitor 1190. When voltage at node 1199 reaches 3 volts, then it begins to turn transistor 11920N.

When FET 1192 turns ON, its resistance goes from essentially infinity to a very low level (e.g., a fraction of an Ohms). In the current fed ballast embodiment, the filament shutoff circuit is activated by the FET 1192 completing a series circuit involving capacitor 1190, optional thermistor 1188 having a negative temperature coefficient, and the secondary winding 1186. This causes a current in the primary winding 1186, which causes each filament current to be shunted away from the filaments. Once the FET 1192 is fully ON, the output voltage 1186 drops to zero or near zero and thus the voltage across each filament is essentially zero, meaning that the filament is not consuming any power. However, depending on the reactance of the combination of resistor 1188, which is temperature dependent, and capacitor 1190, the voltage of the filament could slight above zero volts (e.g., less than one volts at 25 degrees Centigrade or 5 volts at 0 degrees Centigrade). In other words, turning ON FET 1192 causes the voltage across the secondary of the winding 1186 to short out, e.g., to be clamped to essentially zero volts. Once the terminals across the secondary winding of the transformer are at zero volts AC, then the two primary windings must be at zero volts AC as well. Therefore, there is no current flowing through the filaments. In this embodiment, the secondary has 20 turns and each of the primary windings has 5 turns wound in a bifilar manner. This ensures equal voltages are present across both ends of the filaments of the bulb. Further, the two primary windings are electrically isolated from each other and polarized with respect to secondary winding 1186, as well as connected in phase with respect to the signal of the FET switching frequency. The primary windings are in-phase and in parallel with each other. Thus, once FET 1192 is turned ON, the filament current is shut off.

If, for some reason, the voltage to the ballast is interrupted and the bulb is no longer ionized, the start up process begins again. The diode 1196 in conjunction with resistor 1133 ensures the RC circuit (comprising resistor 1195 and capacitor 1194) are effectively drained to zero volts so that the filament shutoff circuit 1180 is reset during a power interruption to the ballast. Thus, if power is shortly returned, the FET 1192 will be initially OFF, allowing current to flow through the filaments during startup.

Thus, during the starting period, the filaments are unaffected by their respective connections to the transformer, but a secondary voltage is produced during start up that charges the capacitor 1190 to the peak of the voltage source across the secondary winding. Similarly, after startup, the value of resistor 1195 with capacitor 1194, forms an RC circuit that delays the time at which the FET 1192 is turned ON.

In some embodiments, a NTC (negative temperature coefficient) resistor or temperature dependent resistor 1188 (also known as a thermistor) may be incorporated to ensure some filament current flows when the ambient operating temperature of the bulb is very low. In other words, the resistor 1188 allows some voltage to be produced across 11986 which is reflected to 1182 and 1184. Further, the volts-seconds rating of the transformer should be sized to limit the current in the filaments. For example, it could be sized to provide a current of 100 mA at 40 khz and 6 volts.

Recall that when the tubes are removed, capacitor 1155 is no longer in the circuit and there cannot be current flowing, either through the filaments or through the tube. In FIG. 11b, capacitor 1154 is illustrated as connected to node 1149. Thus, any current flowing in the tank circuit (passing in series through capacitor 1150, inductor 1152, and capacitor 1154) is detected by feedback circuit 1160. Clearly, this can only occur when the bulb is present. If the bulb is removed, the current terminates and the voltage output from feedback circuit drops to zero. This lack of output voltage can be provided to the ballast and used to shift the frequency of the integrated driver circuit to increase the switching frequency of the ballast. When the switching frequency greatly increases above the resonant frequency of the tank circuit, the voltage across capacitors 1154 and 1155 drops. Thus, removing the tube would be detected by the feedback circuit, and would result in the voltage presented at the nodes 1157 and 1153. This provides a safety feature that is useful when replacing a bulb while the ballast is operational, which often occurs. When a new bulb is installed during operation, the reverse process occurs. Installing a bulb connects capacitor 1155 to the tank circuit, changing the tank circuit's resonance frequency by lowing it. This causes an increase in current in the tank circuit, which is detected by the transformer 1162, which causes a signal voltage to be generated in the bridge circuit, which is used by the ballast to adjust the frequency to provide a higher voltage to the bulb, facilitating ionization of the bulb. If this feature is utilized, then the circuit diagram would be as shown in FIG. 1I c illustrating the output voltage from node 1169 provided to the ballast circuit 1101.

As shown above, the energy saving feature of the feedback circuit 1160 can be used to save energy by shutting off the voltage regulator as well as activating a filament shutoff circuit. It is possible to incorporate both energy saving capabilities in one embodiment, as shown in FIG. 11c. FIG. 11c is a composite of FIGS. 11a and 11b and illustrates the output voltage of the full wave bridge at node 1169 provided to both the ballast circuit 1101 at input 1121 and to resistor 1195. As noted above, the input 1121 can also be used by the ballast to adjust the driver frequency when detecting removal of the bulb. Thus, the other portions of the circuit in FIG. 1I c operate as discussed in FIG. 11a and 11b. The ballast portion 1101 in FIG. 11b and 11c can be of various embodiments and is not limited to that shown in FIG. 11a. However, in FIG. 1I c, because a voltage regulator shutoff signal is provided to ballast, it is assumed that the ballast portion 1101 incorporates a voltage regulator. A diode 1119 is added to prevent any voltage in the ballast from recharging the capacitor 1194 in the tank circuit.

In one embodiment, resistors 1133, and 1195 are 100 k Ohms, resistor 1193 is 10 k Ohms, capacitors 1194 and 1190 are 1 μF, and adjustable resistor 1188 is 0-100 ohms with a negative temperature coefficient. The transformer typically comprises a bifilar winding of 20 turns on the secondary and 5 turns each on the primary windings. Diode 1196 is a 1N4148, and the FET could be an IRF520.

In summary, the energy savings circuitry 1160 and 1180 individually and in combination can improve the efficiency of ballast based lighting systems.

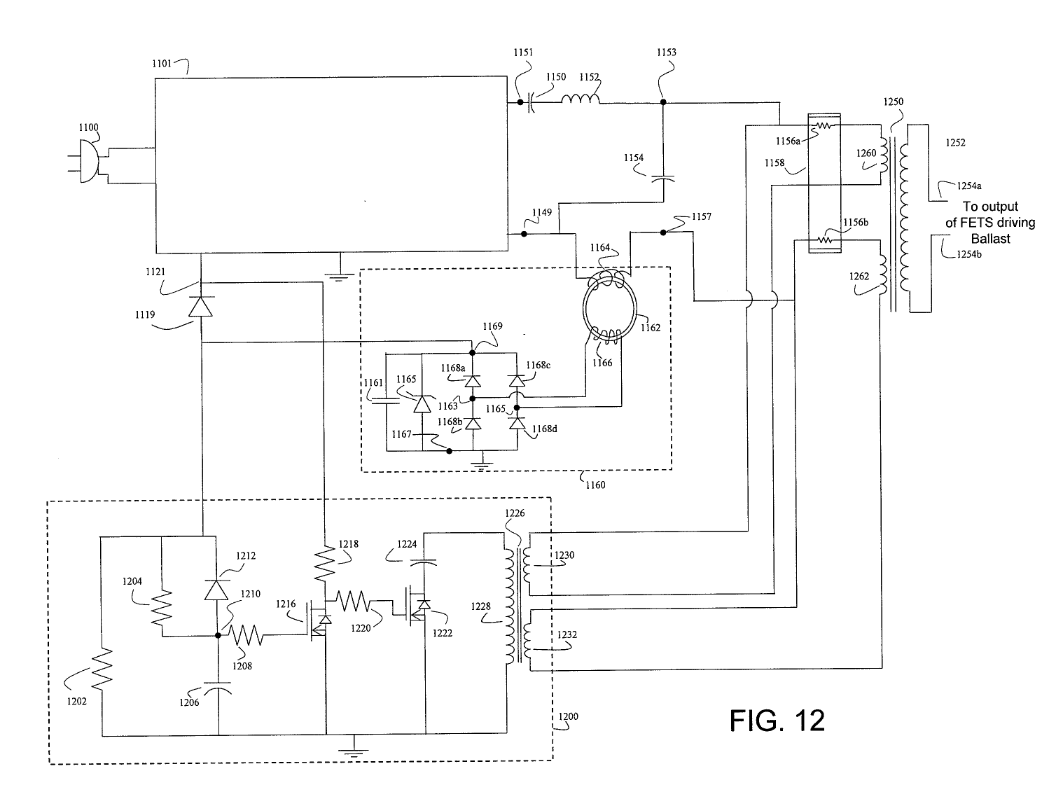

A further embodiment of an energy savings circuit is illustrated in FIG. 12, which is based on the filaments driven by voltage (“voltage fed”), as opposed to being driven by a current (“current fed”). In this embodiment, a voltage is provided across the filaments to facilitate ionization of the bulbs. Once ionization occurs, the voltage is not necessary and can be removed to save energy.

In FIG. 12, the energy savings circuitry comprises feedback circuit 1160 and filament shutoff circuit 1200. In this embodiment, the feedback circuit 1160 operates as discussed before, so no further elaboration is required as to its operation. Different embodiments for the feed back circuit can be used as noted previously. The feedback circuit 1160 provides an output voltage (a signal voltage) at node 1169 to the ballast 1101, which can be used to shut off the voltage regulator, if one is incorporated in the ballast. A diode 1119 prevents voltage from the ballast recharging the capacitor 1194 in the filament shutoff circuit.

In FIG. 12, the tank circuit is similar to that shown in FIG. 11c, in that it comprises capacitor 1150 in series with inductor 1152 connected between nodes 1151 and 1153. Further, capacitor 1154 is connected between node 1153 and node 1149—e.g., capacitor 1154 is connected to the left side of the primary winding 1164. Thus, in this arrangement, if there is no bulb present, then there is no current flowing through the primary winding 1164, but there is current flowing through capacitor 1150, inductor 1152, capacitor 1154 and to node 1149. This can create an unsafe condition, and the absence of any voltage at node 1169 would be indicative of the bulb being absent. As noted before, the voltage at node 1169 can be provided to the ballast and used to alter the switching frequency to reduce the unloaded current in the tank circuit, which reduced the voltage at nodes 1153 and 1157.

The output voltage from the feedback circuit 1160 is also provided to the filament shutoff circuit 1200. The output voltage causes a time-varying voltage to be present at node 1210 in the filament shutoff circuit, via the RC network comprising resistor 1204 and capacitor 1206. The RC network provides a time delay after the ballast is started before the filament shutoff circuit terminates the voltage provided to the filaments.

As the voltage at node 1210 increases in voltage, it causes the gate of FET 1216 to activate the FET. Prior to FET 1216 turning ON, there is no current flowing through the FET and the output voltage from node 1169 is present at the gate of FET 1222, keeping it ON. Thus, prior to FET 1216 turning ON, FET 1222 is ON and the terminals of the secondary winding 1228 are connected in series via capacitor 1224. In other words, when the ballast is initially turned on, FET 1222 is ON and it completes a circuit in the secondary winding. Once FET 1216 is activated, it causes the gate voltage at FET 1222 to drop, which turns FET 1222 OFF. Thus, when the ballast is initially turned ON, FET 1222 is ON but then shortly goes OFF. As discussed below, when FET 1222 is ON, voltage is applied to the filaments to facilitate bulb ionization, but when FET 1222 is OFF, it causes the circuit of the secondary winding to appear as an open circuit. This causes the voltage to the filaments to be removed.

When the ballast is initially powered ON, it is important that FET 1222 is ON so that voltage can be provided to the filaments to facilitate ionization. To ensure that sufficient power is provided to FET 1222, power is provided by connecting resistor 1218 to the node 1121, which receives the voltage regulator output. An alternative embodiment would be to provide power to resistor 1218 from the output of the feedback circuit but this does not necessary ensure that power is initially provided to the FET upon starting the ballast.

Each filament is coupled to two separate transformers. Transformer 1250 is coupled to the square wave output of the FETs driving the tank circuit in the ballast. Thus, the primary winding 1252 of transformer 1250 has a first and second terminal 1254a and 1254b which are connected to the MOSFET outputs at nodes 1151 and 1149 using a DC offset capacitor (not shown). The MOSFETs drive the primary winding at the switching frequency, and a voltage (typically around 6 volts) is generated on the two electrically isolated secondary windings 1260 and 1262. Each secondary winding in turn has a first and second terminal connected in series with a respective filament. Specifically, secondary winding 1260 is connected to filament 1156a which is connected to the primary winding 1230 of the second transformer 1226. Similarly, secondary winding 1262 is connected to filament 1156b which is connected in series with the other primary winding 1232 in transformer 1226.

Thus, when the ballast is first turned ON, the driver MOSFETs provide a voltage to each filament via the isolated circuits described above. When the ballast is first turned on, the primary windings of transformer 1226 interact with the secondary winding 1228. Recall that when the ballast is first turned ON, the FET 1222 is ON, thereby completing the secondary circuit, allowing the filament voltage to be present. Thus, because each primary winding 1230, 1232 is coupled to the secondary winding 1228, a voltage appears across each respective filament in the circuit.

However, when FET 1222 is OFF, the secondary winding 1228 is an open circuit, and there is no coupling between the secondary winding 1228 with each primary winding 1230, 1232. Thus, when the secondary winding opens, a voltage appears across each respective primary winding 1230, 1232 thus negating the voltage appearing across the filament. In essence, if there is no current in the secondary winding 1228, there is no current in the primary windings 1230, 1232, and thus there is no current flowing through the filaments. Without any current flowing through the filaments, there is no voltage across the filaments. Further, if transformer 1260 and 1262 were bifilar wound, this would ensure matching voltages across the filaments of the tube. Consequently, the deactivation of FET 1222 causes the voltage to be removed from the filaments. In this manner, the filament shutoff circuit cooperates with the feedback circuit to reduce the energy consumption of the ballast, and avoids the delivery of unnecessary energy to the filaments.

In one embodiment of FIG. 12, resistor 1202 is 100 k Ohms, resistor 1204 is 3.3 M Ohms, capacitor 1206 is 1 μF, diode 1212 is a 1N4148, resistors 1208 and 1220 are 10K Ohms, resistor 1218 is 1 M Ohms, and secondary winding 1228 has 20 turns and primary windings 1230 and 1232 have 5 turns each, typically in a bifilar winding arrangement. If temperature compensation is desirable, a positive temperature coefficient resistor can be placed across the terminals the terminals of the secondary winding 1228. This would provide filament when temperatures are low to facilitate ionization.

As previously noted, in applications where the bulb is removable, it may be useful to detect when the ballast is powered whether a bulb is installed or not. The absence of a bulb when the ballast is powered may, in certain embodiments, increase the voltage in the tank circuit. Further, in some embodiments, it is desirable to reduce voltage applied to the bulb connectors if no bulb is present. It was previously described how the signal voltage produced by feedback circuit can indicate the presence of the bulb, and that the signal voltage could be used by the ballast to alter the switching frequency, to reduce the voltage in the tank circuit.

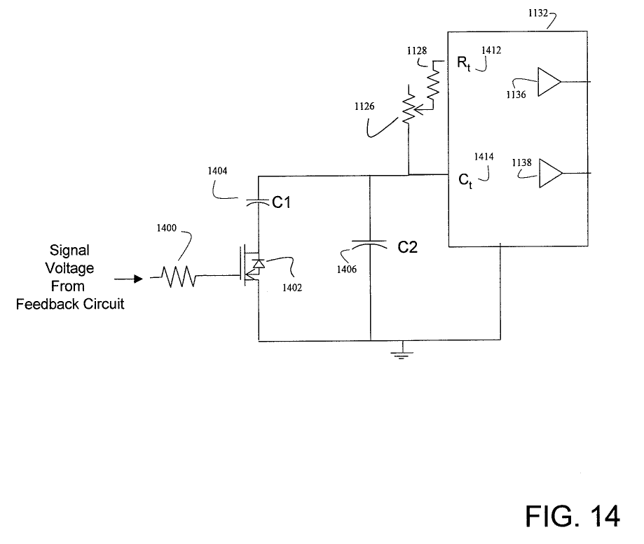

One embodiment of the circuitry to alter the switching frequency based on the signal voltage is shown in FIG. 14. In FIG. 14 only a relevant portion of the ballast circuit is illustrated. The driver integrated circuit 1132 which comprises two drivers 1136 and 1138 which switch at the high frequency is illustrated. In this particular embodiment, the driver integrated circuit 1132 has two inputs Rt 1412 and Ct 1414 that determine the switching frequency. This is determined by an RC circuit where Rt is connected to the resistance leg and Ct is connected to a node where the other resistance leg and a capacitance leg is joined. In this embodiment, the switching frequency is altered by essentially altering the capacitance of the RC circuit. In other embodiments, the signal voltage could be used to alter the resistance.

The resistance portion is determined by resistor 1128 and 1126. Resistor 1126 is a variable value, which can be set so that its value along with resistor 1128 provides the total desired resistance value. Resistor 1128 is not required, but its presence ensures that there cannot be an accidental zero resistance, which could occur if adjustable resistor were adjusted to zero ohms and it was the only resistor present.

The capacitance of the circuit is determined by capacitors C1 1404 and C2 1406. As it will be seen, the capacitance is either just C2, or C1+C2 based on the status of FET 1402. By altering the capacitance, the frequency is altered. Thus, the status of FET 1402 determines the frequency of the driver integrated circuit.

When the signal voltage from the feedback circuit is high (e.g., indicating a bulb is present and the current is flowing in the tank circuit), the voltage is applied via resistor 1400 to the gate of FET 1402 turning it ON. This connects C1 to ground, and results in C1 being in parallel to C2. Thus, the total capacitance is Cₜₒₜₐₗ=C1+C2. The value of Cₜₒₜₐₗ in combination with resistor 1126 and 1128 determines a normal operating frequency of the driver integrated circuit. One skilled in the art would determine these values according to the specification sheet of the integrated circuit provided by the manufacturer.

If however, the signal voltage is low (typically under 2 volts, depending on the specific FET used), this is indicative of the bulb being removed from the ballast. If the signal voltage is low, then the FET 1402 is OFF, and C1 is not connected to ground, but is an open circuit. Thus, C1 is not in parallel with C2, and the total capacitance is Cₜₒₜₐₗ=C2. This different capacitance in combination with resistor 1126 and 1128 determines a second operating frequency of the driver integrated circuit. This frequency is typically higher than the normal operating frequency, such that the voltage in the tank circuit is reduced. When the bulb is installed, the signal voltage goes high, and causes the frequency to shift back to the normal operating frequency.

In this embodiment, it is preferred to incorporate a capacitor 1161 in FIG. 12 in the feedback circuit to reduce the ripple voltage in the signal voltage, and prevent the FET 1402 from turning ON and OFF.

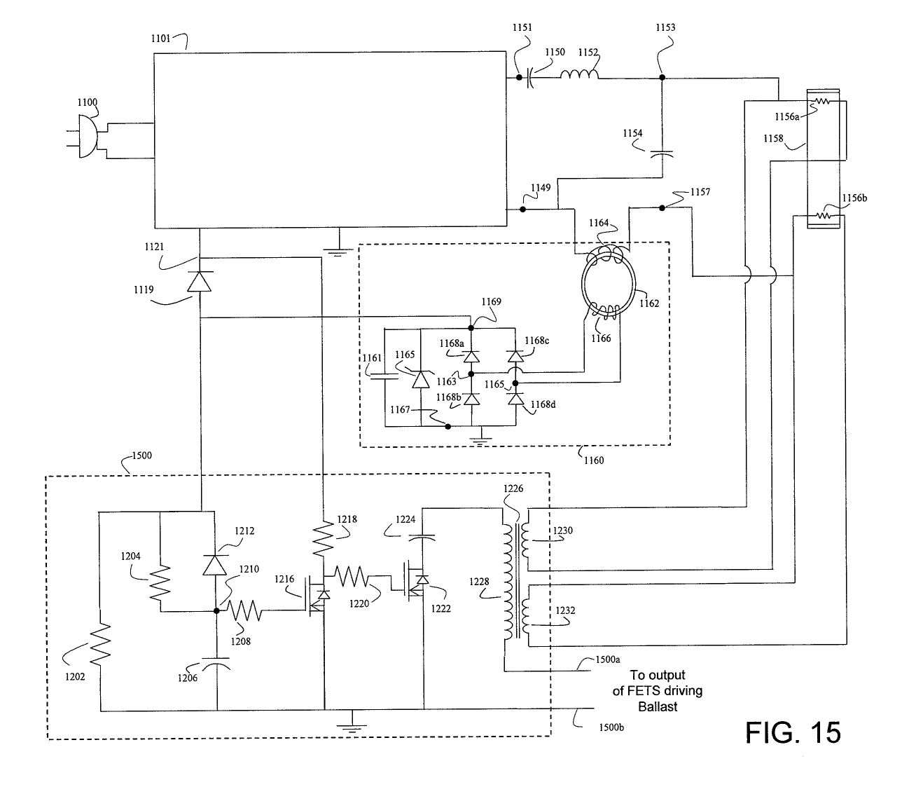

FIG. 15 illustrates another embodiment of an energy savings circuit configured to reduce the voltage on the bulb filaments in a voltage driven ballast. In FIG. 15, the feedback circuit 1160 is as previously discussed, and no additional explanation of its operation is necessary. The filament shutoff circuit 1500 is very similar to that previously disclosed. However, in FIG. 15, there is only one transformer required. The transformer 1226 is configured with one primary and two secondary windings. Note that in this embodiment, the windings are reversed, e.g., winding 1228 is the primary (not secondary winding) and windings 1230, 1232 are the secondary windings (not the primary windings). In this case, the primary winding is coupled to the FET outputs which drive the tank circuit. Thus, the terminals on the primary winding 1500a, 1500b receive the square wave voltage from the FETs once the ballast is turned on. When the ballast is initially turned on, FET 1222 is ON as described earlier. Thus, FET 1222 completes the circuit in the primary winding so that the square wave voltage at terminals 1500a and 1500b is presented. This, in turn, causes a voltage to appear across each respective secondary winding. Each respective secondary winding is coupled as shown to a respective filament in the bulb. Thus, the voltage produced on each secondary winding is present across the filaments of the bulb.

When the time varying voltage at node 1210 increases causing FET 1216 to turn ON, this in turn causes FET 1222 to turn OFF as described earlier. Once FET 1222 turns OFF, the circuit in the primary winding 1228 of the transformer 1226 is opened. Once this occurs, no further voltage is induced on each respective secondary windings, and the respective voltages across the filaments is reduced. Thus, this embodiment also reduces energy consumed by the ballast during operation.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A ballast circuit for a gas-discharge lamp comprising:
a tank circuit comprising:
a first node, wherein a first capacitor is connected in series with an inductor between said first node and a second node,
a second capacitor having a first terminal and a second terminal, wherein said first terminal is configured to be connected to a first terminal of a first filament of said gas-discharge lamp, said second terminal configured to be connected to a first terminal of a second filament of said gas-discharge lamp,
wherein a second terminal of said first filament is configured to be connected to said second node and a second terminal of said second filament is configured to be connected to a third node; and
a feedback circuit comprising:
a transformer having a primary winding having a first terminal and a second terminal wherein said first terminal is connected to a fourth node and said second terminal is configured to be connected to said third node such that a current passing in said tank circuit passes through said primary winding, said transformer having a secondary winding with a first terminal and a second terminal providing an alternating voltage, and
a rectifier circuit receiving said alternating voltage, said rectifier circuit producing a signal voltage in response to said alternating voltage.

2. The ballast circuit of claim 1 wherein the secondary winding comprises a number of turns that is five times a number of turns of the primary winding.

3. The ballast circuit of claim 1 wherein the signal voltage produced is greater than 12 volts.

4. The ballast circuit of claim 1 wherein the signal voltage provides power to operate an integrated circuit driver chip in the ballast.

5. The ballast circuit of claim 4 configured so said integrated circuit driver chip operates at a first frequency when said signal voltage is of a first value and said integrated circuit driver chip operates at a second frequency when said signal voltage of a second value.

6. The ballast circuit of claim 1 further comprising a voltage regulator receiving said signal voltage wherein said voltage regulator is configured to deactivate upon receipt of said signal voltage.

7. The ballast circuit of claim 1 further comprising:
a filament shutoff circuit receiving said signal voltage and configured to reduce current passing through the first filament and the second filament in response to receiving said signal voltage.

8. The ballast circuit of claim 7 further comprising a third capacitor having a first terminal and a second terminal, wherein said first terminal is connected to said second node and said second terminal is connected either to said fourth node or to said third node.

9. The ballast circuit of claim 1 further comprising:
a filament shutoff circuit receiving said signal voltage and configured to reduce a voltage across said first filament in response to receiving said signal voltage.

10. A ballast circuit for a gas-discharge lamp comprising:
a voltage regulator for providing a regulated voltage when activated, said regulated voltage used in said ballast;
an integrated circuit receiving said regulated voltage, said integrated circuit generating a square wave signal;
a tank circuit configured to be connected to a gas-discharge lamp, said tank circuit receiving said square wave signal;
a feedback circuit for detecting current in said tank circuit and generating a signal voltage in response to said current, wherein said signal voltage is provided to power said integrated circuit, wherein said signal voltage is also provided to said voltage regulator causing said voltage regulator to cease providing said regulated voltage.

11. The ballast circuit of claim 10 further comprising:
a filament shutoff circuit receiving said signal voltage and configured to reduce a voltage across a first filament of said gas-discharge lamp after a time delay from when receiving said signal voltage.

12. The ballast circuit of claim 10 further comprising:
a filament shutoff circuit receiving said signal voltage and configured to reduce a current flowing through a first filament and a second filament of said gas-discharge lamp after a time delay from when receiving said signal voltage.

13. A ballast circuit for a gas-discharge lamp comprising:
a tank circuit configured to be connected to a gas-discharge lamp, wherein said gas-discharge lamp has a first filament and a second filament;
a feedback circuit for detecting current in said tank circuit and generating a signal voltage in response to said current;
a filament shutoff circuit receiving said signal voltage, said filament shutoff circuit configured to reduce energy provided to said first filament and said second filament after a time delay from when said filament shutoff circuit received said signal voltage.

14. The ballast circuit of claim 13 wherein said filament shutoff circuit comprises:
a transformer having a first primary winding and a second primary winding, wherein said first primary winding is connected to said first filament, and said second primary winding is connected to said second filament,
said transformer having a secondary winding having a first terminal and a second terminal, said first terminal coupled to a first terminal of a transistor and the second terminal coupled to a second terminal of the transistor, wherein said transistor is configured to be activated to couple said first terminal and said second terminal of said transistor after a time period after said filament shutoff circuit receives said signal voltage thereby causing a circuit to be formed from said first terminal of said secondary winding to said second terminal of said secondary winding.

15. The ballast circuit of claim 14 wherein the transistor has a third terminal coupled to a fourth node, wherein said fourth node has a time varying second voltage produced as a result of providing said signal voltage to said filament shutoff circuit.

16. The ballast circuit of claim 14 wherein forming said circuit from said first terminal of said secondary winding to said second terminal of said secondary winding causes a reduction in current flowing through said first filament and said second filament.

17. The ballast circuit of claim 13 comprising:
a voltage regulator configured to cease providing a regulated voltage upon receipt of said signal voltage from said feedback circuit.

18. A ballast circuit for a gas-discharge lamp comprising:
a tank circuit configured to be connected to a gas-discharge lamp, wherein said gas-discharge lamp has a first filament and a second filament;
a feedback circuit for detecting current in said tank circuit and generating a signal voltage in response to said current;
a filament shutoff circuit comprising:
a first transformer having a primary winding receiving an alternating voltage, said first transformer having a first and second secondary winding, wherein the first secondary winding has a first terminal connected to a first terminal of said first filament and said second secondary winding has a first terminal connected to a first terminal of said second filament;
a second transformer, having a first and second primary winding, wherein
said first primary winding has a first terminal connected to a second terminal of said first filament, said first primary winding having a second terminal connected to said second terminal of said first secondary winding of said first transformer,
said second primary winding having a first terminal connected to a second terminal of said second filament, said second primary winding having a second terminal connected to second terminal of said second secondary winding of said first transformer,
said second transformer having a secondary winding having a first terminal and a second terminal; and
a first transistor having first terminal and a second terminal respectively coupled to said first and second terminal of said secondary winding of said second transformer, wherein said first transistor is configured to turn OFF after a time delay from when said filament shutoff circuit receives said signal voltage thereby opening a circuit.

19. The circuit of claim 18 further comprising:
a second transistor configured to receive said signal voltage from said feedback circuit and configured to turn OFF said first transistor after said time delay.

20. The circuit of claim 18 configured wherein when said circuit is opened, there is no current flowing through said first primary winding of said second transformer and said second primary winding of said second transformer.

21. A ballast circuit for a gas-discharge lamp comprising:
a tank circuit configured to be connected to a gas-discharge lamp, wherein said gas-discharge lamp has a first filament and a second filament;
a feedback circuit for detecting current in said tank circuit and generating a signal voltage in response to said current;
a filament shutoff circuit receiving said signal voltage, said filament shutoff circuit comprising:
a transformer having a first secondary winding with a first terminal and a second terminal respectively coupled to a first terminal and a second terminal of said first filament,
said transformer having a second secondary winding with a first terminal and a second terminal respectively coupled to a first terminal and a second terminal of said second filament,
said transformer having a primary winding with a first and second terminal connected respectively to a first and second terminal of a transistor, wherein said filament shutoff circuit is configured to open a circuit between said first terminal and said second terminal of said transistor after a time delay after said filament shutoff circuit receives said signal voltage.

22. A method for reducing energy used in a lighting circuit comprising a ballast comprising a voltage regulator and an integrated circuit driving a tank circuit, wherein said ballast is configured to produce a voltage to a gas discharge lamp during operation of said ballast, comprising the steps of:
detecting a first current flowing through the tank circuit;
generating a signal voltage in response to said first current;
providing said signal voltage to said integrated circuit; and
receiving said signal voltage at said voltage regulator of said ballast wherein said signal voltage results in deactivating said voltage regulator and causing said integrated circuit to operate using said signal voltage.

23. A method for reducing energy used in a lighting circuit comprising a ballast comprising a tank circuit, wherein said ballast is configured to produce a voltage to a gas discharge lamp having a first filament and a second filament during operation of said ballast comprising the steps of:
detecting a first current flowing through the tank circuit;
generating a signal voltage using a first transformer in response to detecting said first current flow; and
providing said signal voltage to a filament shutoff circuit wherein said filament shutoff circuit reduces a current flowing through said first filament and said second filament.

24. The method of claim 23 further comprising the step of:
causing a second transformer having a secondary winding having a first terminal and a second terminal to have completed a circuit across said first terminal and said second terminal as a result of receiving said signal voltage, thereby causing a first primary winding of said second transformer having a first terminal and a second terminal, and a second primary winding having a first terminal and a second terminal, to each have equal voltages across their respective first terminal and said second terminal.

25. The method of claim 23 further comprising the steps of:
providing said signal voltage to said filament shutoff circuit so as to cause a time varying voltage;
providing said time varying voltage to a transistor;
activating said transistor, thereby causing said transformer with said secondary winding to complete a circuit across said first and second terminal of said secondary winding.

26. A method for reducing energy used in a lighting circuit comprising a ballast comprising a tank circuit, wherein said ballast is configured to produce a voltage to a gas discharge lamp having a first filament and a second filament during operation of said ballast comprising the steps of:
detecting a first current flowing through the tank circuit;
generating a signal voltage using a transformer in response to detecting said first current flow; and
providing said signal voltage to a filament shutoff circuit wherein said filament shutoff circuit reduces a voltage across said first filament.

27. The method of claim 26 further comprising the steps of:
providing a square wave voltage at the primary winding of a first transformer, said first transformer having a first secondary winding and a second secondary winding, wherein said first secondary winding has a first terminal connected to said first filament and said second secondary winding has a first terminal connected to said second filament;
generating a voltage across said first filament and said second filament in response to said square wave at the primary winding;
creating an open circuit across a first terminal and second terminal of a secondary winding of a second transformer after a time delay of when said signal voltage is received by said filament shutoff circuit,
wherein said second transformer has a first primary winding and a second primary winding,
wherein further said first primary winding has a first terminal connected to said first filament and a second terminal connected to a second terminal of said first secondary winding of said first transformer,
wherein further said second primary winding of said second transformer has a first terminal connected to said second filament and a second terminal connected to a second terminal of said second secondary winding of said first transformer; and
reducing a voltage across said first filament and said second filament in response to said open circuit on the secondary winding of said second transformer.

28. A method for reducing energy used in a lighting circuit comprising the steps of:
detecting a first current in a tank circuit wherein said tank circuit including a gas discharge lamp;
generating a signal voltage in response to said first current;
receiving said signal voltage at a filament shutoff circuit; and
activating a transistor in said filament shutoff circuit after a time delay in response to receiving said signal voltage,
wherein activation of said transistor after said time delay opens or closes a circuit across a first terminal and a second terminal of a first winding of a transformer,
wherein said opening or closing the circuit across said first terminal and said second terminal of said first winding of the transformer reduces a voltage across a first terminal and a second terminal of a second winding of said transformer.

29. The method of claim 28 wherein said energy reduced is accomplished by removing a current flowing through said first filament when closing the circuit across said first terminal and said second terminal of said first winding of the transformer.

30. The method of claim 28 wherein said energy reduced is accomplished by removing a voltage across said first filament when opening the circuit across said first terminal and said second terminal of said first winding of the transformer.
